(19) United States
(12) Patent Application Publication
(10) Pub. No.: US 2004/0103367 A1
(43) Pub. Date: May 27, 2004

(54) Facsimile/machine readable document processing and form generation apparatus and method

(76) Inventors: Larry Riss, Morgan Hill, CA (US); Suresh Pandian, Sunnyvale, CA (US); Johnson Pushpanathan, Cupertino, CA (US); Krishna Srinivasan, Fremont, CA (US); Thyagu Swaminathan, Cupertino, CA (US)

Correspondence Address: NIXON & VANDERHYE, PC, 1100 N GLEBE ROAD, 8TH FLOOR, ARLINGTON, VA, 22201-4714, US

(21) Appl. No.: 10/361,853

(22) Filed: Feb. 11, 2003

Related U.S. Application Data
(60) Provisional application No. 60/428,918, filed on Nov. 26, 2002.

(51) Int. Cl. G06F 17/00

(52) U.S. Cl. 715/506; 715/513

(57) ABSTRACT

A multiple server computer system generates standard documents, after receiving customer order requests, invoices, etc., of disparate design via, for example, a facsimile transmission or via the Internet in machine readable form. When, for example, a facsimile-related end user purchase order form is received, an image is placed into a database without, for example, initially attempting to read the image content. Thereafter, the fax image is retrieved, and the system determines what kind of document has been received. An appropriate template for that received form is then retrieved. The end user purchase order form is then read, data is extracted therefrom and placed into the standard document template format for review and possible error correction. After a correct form is obtained and accepted, the document is converted, for example, to XML and stored and used to generate standard documents as EDI documents.

### CROSS-REFERENCES TO RELATED APPLICATIONS

This application claims the benefit of Provisional Application No. 60/428,918, filed Nov. 26, 2002, the entire content of which is hereby incorporated by reference in this application.

### FIELD OF THE INVENTION

The invention generally relates to a machine-readable document and image/facsimile document processing and distribution apparatus and methodology. More particularly, the invention relates to a system and method for receiving documents in various forms including image/facsimile documents and machine-readable format documents, processing such received documents in a manner to reduce labor intensive data entry, and generating in an efficient manner standardized forms which may be useful, for example, as purchase orders, applications for government grants, or any of a wide range of applications.

### BACKGROUND AND SUMMARY OF THE INVENTION

With the advent and widespread use of the Internet many computer scientists and corporate managers have recognized the advantages of conducting personal and business transactions via the Internet. For example, it is commonplace today for purchases to be made via Internet based electronic commerce channels.

Notwithstanding the advantages and efficiencies of electronic commerce, longstanding conventional methods for ordering goods and services continue to be widely used in the United States and throughout the world. Particularly with respect to individuals and small organizations, longstanding conventional modes of placing orders, such as via facsimile transmission or by mail, are widely used and often constitute a high percentage of the transactions for a given corporation (even though the transaction amounts may be individually relatively small).

Large corporations placing orders with a corporate trading partner are more likely to be sophisticated enough to be utilizing electronic commerce techniques by, for example, placing orders using well recognized electronic commerce standards such as the electronic data interchange (EDI) standard. Nevertheless, corporate entities are often flooded with orders received via facsimile transmission and mail.

Processing, for example, orders received by facsimile is very labor intensive. Corporations often attempt to design and utilize a trustworthy facsimile distribution system to eliminate problems with lost or misdirected facsimiles. Such received faxes are often forwarded to data entry personnel to enter data contained in these faxes to ultimately generate standardized documents within the corporation for purchasing products and/or services.

The exemplary embodiments of the present invention advantageously reduce data entry requirements by data entry personnel, provide a vehicle for electronic collaboration via forms, and efficiently process received documents of disparate types.

In accordance with an exemplary embodiment of the present invention, a unique computer system receives customer order requests, applications for government grants, etc., of disparate design via, for example, a facsimile transmission or via the Internet in machine readable form. When, for example, a facsimile-related end user purchase order form is received, a fax image is placed into a database without, for example, initially attempting to read the image content. After a document processing system user queries the database for new fax arrivals, the fax image is retrieved, and the system determines what kind of document has been received. Thereafter, an appropriate template for that received form is retrieved (presuming a template has been created for the end user purchase order format received). The end user purchase order form is then read, data is extracted therefrom and placed (or “zoned”) into the standard document template format for review and possible error correction. After a correct form is obtained and accepted, the document is converted, for example, to Extensible Markup Language (XML) and stored.

In accordance with an exemplary embodiment of the present invention, the system described herein processes machine-readable or “rich” documents (such as a word document, an Excel document or an XFORMS document), which are not required to be scanned by, for example, by an optical character reader (OCR). The system also processes “image” documents which have to be scanned including those which are received through physical mail.

In accordance with an exemplary embodiment of the present invention, such machine-readable and image documents are processed as attachments to e-mail transmissions or submitted to the system via a web service, and which are subsequently extracted to ultimately generate such standard documents as EDI documents. EDI is one exemplary standard electronic commerce-related document format which specifies how an electronic commerce purchase order is structured. In accordance with an exemplary embodiment, a received electronic document via an e-mail attachment or submission by a web service is converted to an intermediate document in XML format using a standard document template and then converted to the standard format such as an EDI or other standard document format for routing to the line of business application.

The present methodology enhances the accuracy of final product forms generated in accordance with the exemplary embodiments. Such enhanced accuracy flows in part from eliminating the amount of data entry required by data entry personnel and the human error associated therewith.

Additionally, the accuracy of the resulting data is enhanced during the data conversion process. During this process, in the illustrative embodiments, mandatory fields for which data must be entered are identified. Further, characteristics of various form fields are stored. Thus, for example, whether a field requires entry of alphabetic data, numeric data, or both may be stored. Any departure from the expected type of data for such mandatory fields is detected and system users are prompted to correct any such detected errors. The template design program leads the user through the template design so as to identify significant characteristics. This data is stored in a database. When a new end user form is read and processed during the conversion process, comparisons with stored characteristic data are made to determine the accuracy of the data. In this fashion, missing fields and erroneous data (e.g., entry, for example, of alphabetic information when numeric information was expected) may be detected.

### BRIEF DESCRIPTION OF THE DRAWINGS

These, as well as other features of the present exemplary embodiments will be better appreciated by reading the following description of the preferred embodiment of the present invention taken in conjunction with the accompanying drawings of which

FIG. 1 is a logical architecture overview of the major hardware/software systems in accordance with an exemplary embodiment of the present invention.

FIG. 2 is a high level block diagram showing system components in accordance with an exemplary embodiment of the present invention.

FIG. 3 is an illustrative block diagram showing an exemplary implementation in an environment where a high volume of documents are required to be processed.

FIG. 4 is a block diagram which shows in further detail certain aspects of an illustrative system architecture in accordance with an exemplary embodiment of the present invention.

FIG. 5 is an example of a purchase order in XML.

FIG. 6 is a work flow diagram delineating the sequence of operations performed during the document conversion process.

FIG. 7 is an exemplary screen display depicting an image document in the form of a customer's original purchase order in the process of being mapped to a template standard document purchase order.

FIG. 8 is a screen display which shows the data extracted from the customer's purchase order form and inserted into the standard document purchase order template.

FIG. 9 shows a customer purchase order in Word format and the counterpart standard document Word purchase order template.

FIG. 10 shows a word type document counterpart to FIG. 6.

FIG. 11 is the counterpart output XML document to the FIG. 3 document.

FIGS. 12A and 12B show an exemplary http(s) receiver and receiver related data base, respectively

FIG. 13 illustrates an exemplary implementation for the multi-channel engine shown in FIG. 2.

FIG. 14 is a block diagram of a more detailed representation of the infrastructure control module.

FIG. 15 is an exemplary system data base block diagram.

FIG. 16 is an exemplary block diagram of an illustrative implementation of the template designer module.

FIGS. 17A and 17B are flowcharts delineating sequences of operations relating to the template design process.

FIG. 18 is a screen display which illustrates the process of mapping raw input data to fields in a template.

FIG. 19 is an exemplary screen display used by a customer service representative at the document correction utility.

### DETAILED DESCRIPTION OF THE PRESENT AND PREFERRED EMBODIMENTS

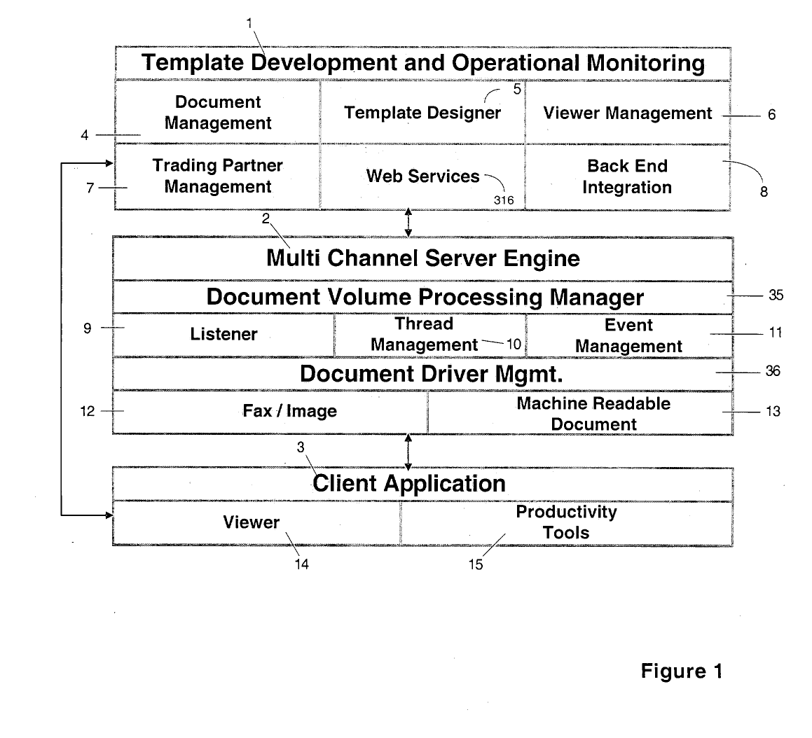

FIG. 1 is a high level overview of an exemplary organization of major hardware and software components in accordance with an exemplary embodiment of the present invention. As shown FIG. 1, a template development and operational monitoring system 1 operates to manage documents which are received, and to design templates. The template development and operational monitoring system 1 is coupled to a multi-channel server engine 2 which converts the output of the template development system 1 into a document in the proper form such as, for example, an XML document which in turn can be converted into a final form such as, for example, an EDI document. Additionally, a multi-channel engine client application 3 interacts with multi-channel server engine 2 to assist in performing error detecting/correcting activities while viewing documents being processed. Client application 3 also interacts with the template development system 1 as will be explained further below.

It should be understood that the subsystems shown in the template development system 1, the multi-channel server engine 2, and the client application system 3 are shown, for illustration purposes only, to explain certain aspects of the exemplary embodiments of the present invention. Certain modules may, for example, be combined with others, performed in another portion of the system or be left out of the system in a given implementation.

Turning back to the template development and operational monitoring system 1, this system supports the processing and management of received documents of any of a wide variety of types. The document management system 4, template designer 5, and viewer management system 6 coact in the document template development and setup process. Document management system 4 retrieves documents from a queue and identifies the type of document, e.g., Microsoft Word document, PDF document or image document, for further processing.

The template designer 5 creates documents that are managed by the document management system 4. The template designer 5 stores and retrieves documents and applies predefined rules for generating a template document. In designing a template document, various characteristics of an input document are mapped to predefined portions of the template document. As part of the template design process, a viewer management system 6 controls the display of the customer's input form and the template being generated during the template design process. Thus, through split screen techniques, a user can see both the original document and the resulting template created by mapping fields from the originating document onto the template.

The trading partner management system 7 links, for example, a customer (trading partner) who is forwarding, for example, a purchase order with the purchase order format that is characteristic of that customer. The overall system in FIG. 1 then operates to convert the format typical of the customer to a normalized XML based purchase order format in accordance with, for example, EDI. Thus, for example, each corporate customer using the system, in accordance with an exemplary embodiment, may utilize its own distinct internal purchase order format, which may be transmitted, for example, via facsimile. Each of the disparate purchase order formats will be converted into a common standard format for further processing. Thus, the trading partner management system 7 links a customer identification with the customer's document format such that appropriate conversion rules may be applied to convert such a format to a standard format such as EDI. Back end integration system 8 operates to deliver the document to the required destination.

The customer may choose to transmit documents via, for example, a common email system. However, the overall system shown in FIG. 1 supports web services 316 as an alternative method for submitting documents. Documents submitted via web services 316 provide for additional control and security. Besides document submission, any external data, for example trading partner registration information, may be submitted to the overall system via web services 316.

Turning next to the multi-channel server engine 2, this engine includes a document volume processing manager 35 which includes a listener (document extractor/monitoring system) 9, which monitors when documents have arrived for processing. The listener 9 detects the arrival of the documents and the document type. A thread management system 10 performs the necessary processing to ensure that the application is readily scalable. For example, if documents are received every two minutes, no enhanced processing capability for high volume is required. However, if documents are received at extremely high volume, the system hardware should be capable of processing at speeds required to properly handle such volume. The thread management system 10 ensures that processing capability will scale up as necessary. For example, if the system hardware includes multiple processors, then multiple threads may be processed in parallel.

An event management system 11 responds to various events such as, for example, the receipt of a document and triggers the required operation to be performed. The event management system 11 also responds to the detection of an error event.

The server engine 2 also includes a document driver management system 36. The document driver system 36 includes distinct driver software depending upon the nature of the document. The document driver management system 36 is used to dispatch the appropriate parser depending on the document type submitted by the customer, for example a FAX, Word, PDF, XFORM or some other format.

Such driver software includes fax/image document driver software 12 and machine readable document driver software 13. Thus, document processing will differ depending upon whether the document is determined to be a fax or image document or a machine readable document (which would include, for example, a word document or any other type of machine readable document).

In accordance with an exemplary embodiment, the system additionally includes a client application system 3 which may be embodied in a PC and includes a viewer subsystem 14 and productivity tools 15. The viewer subsystem 14 permits a user to view an original document and a document undergoing conversion to a standard document format. The client application 3 provides the system user with a set of productivity tools 15 depending upon the role of the user in the corporate environment and access capability built into the user's password. Productivity tools may permit a user to design templates, manage documents, correct documents, etc., based on the user's access authority. The client application module 3 interacts with both the template development system 1 and the multi-channel server engine 2.

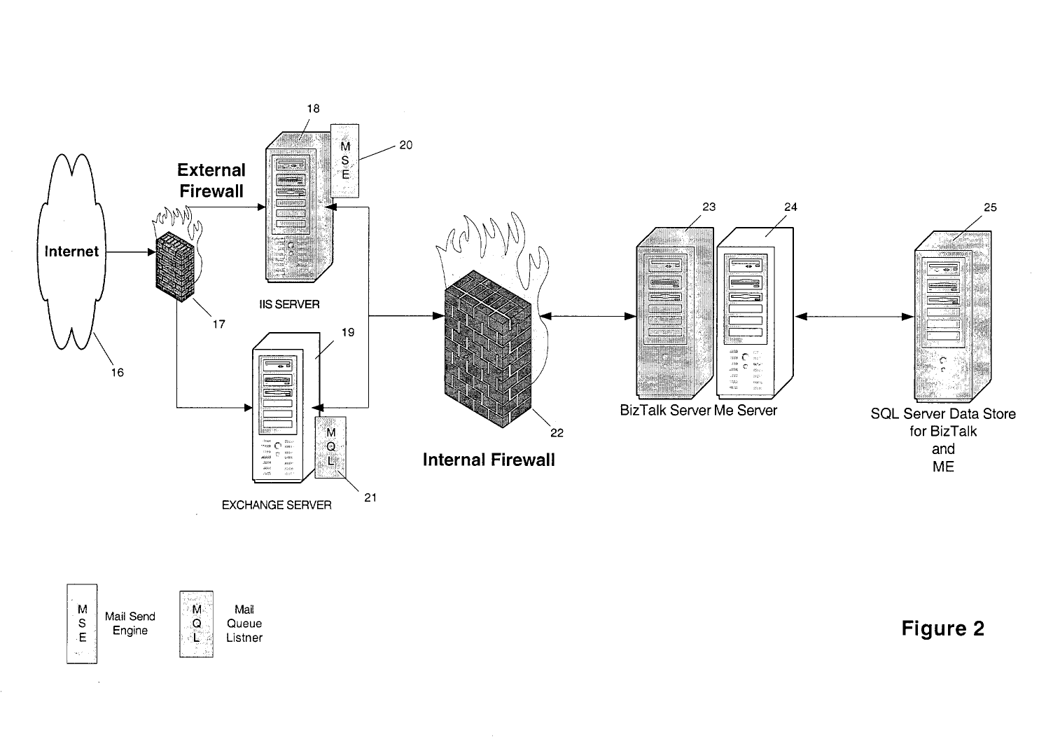

FIG. 2 is a high level block diagram showing illustrative system components in accordance with an exemplary embodiment of the present invention. As will be explained further below, various types of documents may, for example, be received via the Internet 16. An external firewall 17 is utilized to prevent unauthorized access to system servers. In accordance with an exemplary embodiment of the present invention, the external firewall may run a non-Windows operating system to confuse intruders. A conventional IIS server 18 is used to manage web pages and web access. An exchange server 19 is utilized as the initial repository for incoming documents. Associated with IIS 18 is a mail send engine (MSE) 20. Associated with the exchange server 19 is a mail queue listener (MQL) 21, which retrieves mail from a mail queue and determines, for each retrieved e-mail, the number of attachments that are associated therewith. The mail queue listener 21 operates to retrieve each attached document and store the attached document in the SQL server data store 25 via the internal firewall 22 and servers 23 and 24.

Internal firewall 22 may be a conventional internal firewall within a corporate entity. The document information, after being transported via internal firewall 22 is processed and routed through a system including a conventional server 23, which for example, may be Microsoft Biztalk server, and a multi-channel engine server 24 which is described in detail below. The SQL server data store 25 is utilized by both servers as the system data repository.

The system shown in FIG. 2 supports bidirectional communications. Appropriate notifications to remotely located parties are sent via the Internet to end users as described below.

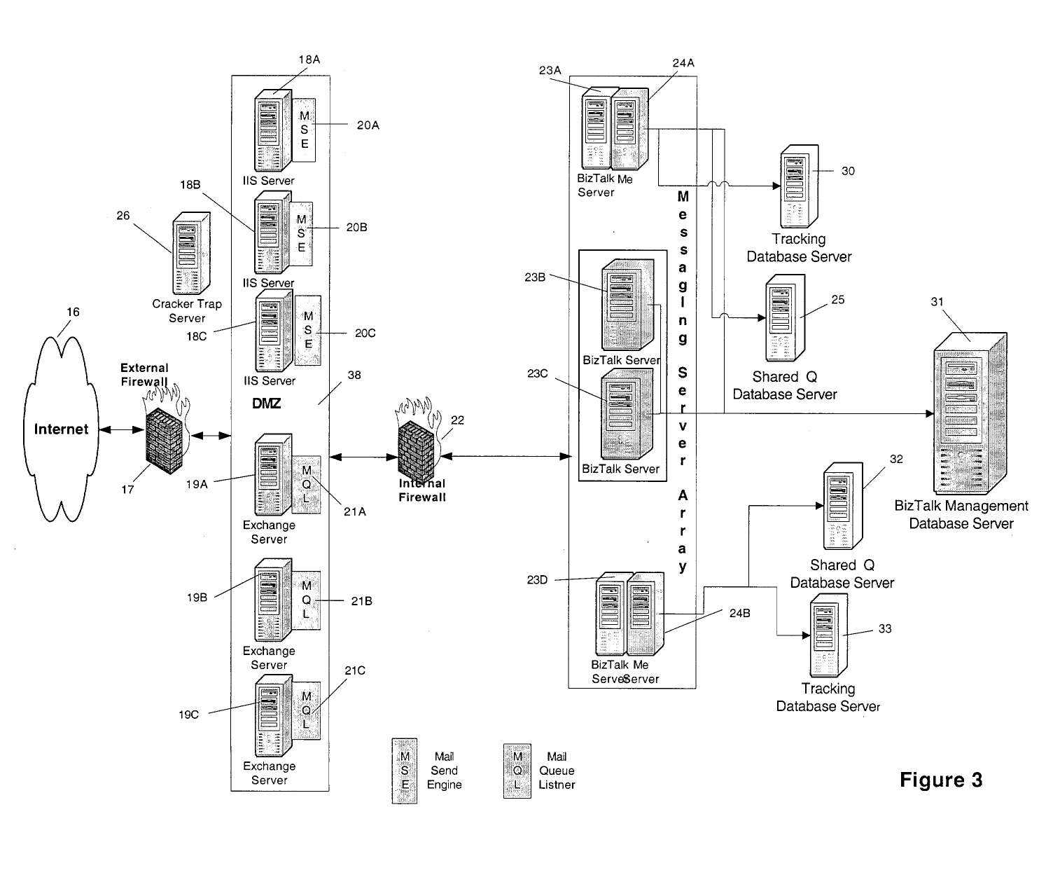

FIG. 3 is an illustrative block diagram showing an exemplary implementation in an environment where a high volume of documents are required to be processed. In the exemplary embodiments of the present invention, the system may be scaled up or scaled down in terms of processing capability depending upon the need for high volume/multi-processing capabilities. The FIG. 3 components which are the same as shown in FIG. 2 are identified by corresponding reference numbers.

As previously described in conjunction with FIG. 2, documents may be received into the system, for example, via the Internet 16, and external firewall 17. In accordance with an illustrative embodiment of the present invention, a cracker trap server 26 may be utilized. Telnet, RPC and other non-http, non-SMTP ports are rerouted to this server by firewall 17. The server 26 preferably runs intrusion detection software and may be a Biztalk-type server that will enable Telnet, RPC, simple TCP/IP services.

Documents are received by receiver 38, which is implemented by a pool of IIS servers 18A, 18B and 18C. Additionally, e-mail messages may be received by exchange servers 19A, 19B and 19C. The multiple servers are shown to reflect the contemplated multi-processing capability to support high volume processing capability. Information flow through the pool of servers is supported by mail send engines 20A, 20B and 20C and mail queue listeners 21A, 21B, 21C. The mail queue listeners 21A-21C pull out of the e-mail system, the documents attached thereto and send the documents through internal firewall 22 to a message server array. The message server array is, by way of example only, shown as being various combinations of a conventional Biztalk server 23A, 23B, 23C and 23D and multi-channel server 24A, 24B described in detail below.

If the load of documents to be processed is largely facsimile images (which require significant CPU intensive activity by a multi-channel engine 24A described below), more multi-channel engine servers 24A would be utilized in such an implementation.

Multiple database servers may be utilized, such as shared Q database server 25 and 32 depending upon the volume of data to be stored. It should be understood that either one database or multiple databases may be utilized.

By way of example only, a separate BizTalk Management database server 31 is shown for use by the document routing Biztalk server. Tracking database servers 30 and 33 are utilized to track documents flowing through the system. These databases store, for example, information indicating how many documents flow through the system, how many were converted successfully, how many failed and other related information.

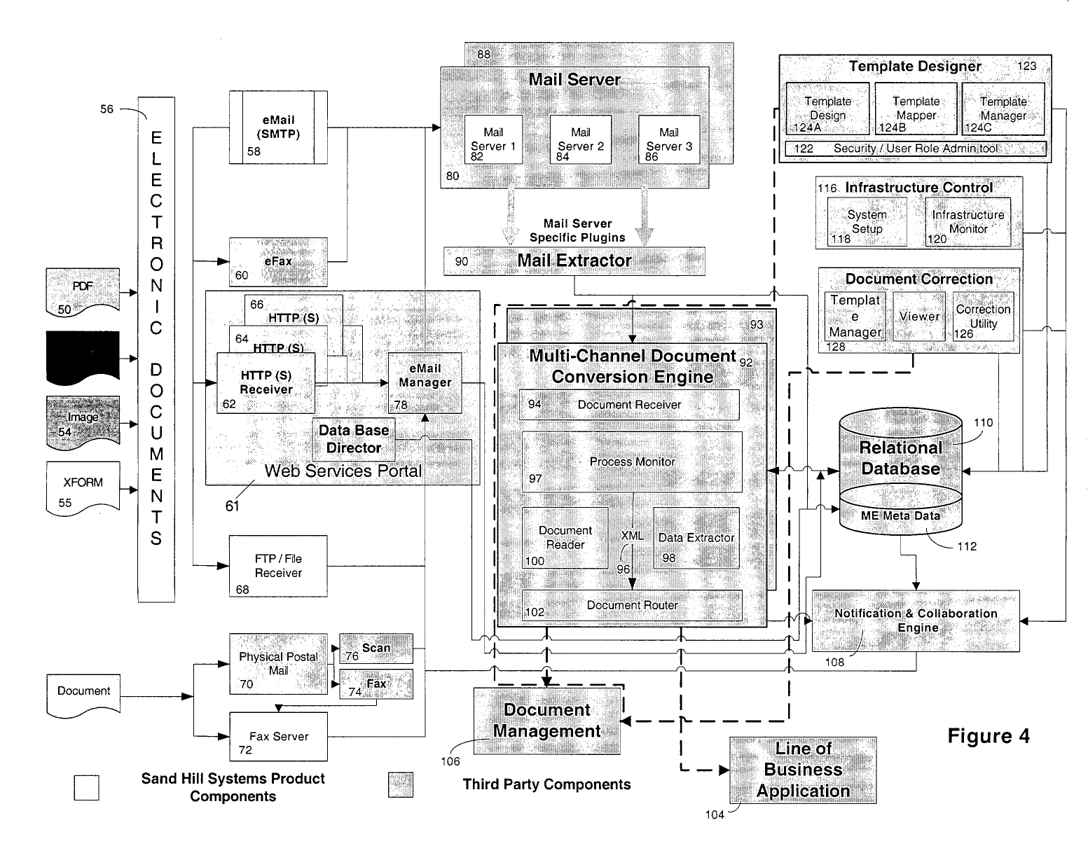

FIG. 4 is a block diagram, which shows in further detail certain aspects of an illustrative system architecture in accordance with an exemplary embodiment of the present invention. This illustrative system receives, via a wide range of multi-channel inputs, any document type, such as a PDF document 50, a Word document 52 an image document 54 or an XFORMS document 55. It should be understood that other document types are also contemplated and that the four document types shown are for purposes of illustration only.

Documents to be submitted 50, 52, 54 and 55 via some electronic means (as represented by Electronic Documents 56) are delivered to the Multi-Channel Document Conversion Engine 93 by various transport technologies such as eMail 58, eFax 60, Web Services Portal 61, FTP 68. Physical media such as mail 70 and fax 72 can also be submitted by converting them to electronic form via, for example, a scanner 76 or a fax server 72. In an exemplary embodiment, the input documents 56 and physical documents 70 and 72 are routed to the Mail Server(s) 80. This allows a consistent method for submission of documents to the Multi-Channel Document Conversion Engine 93, and acts as a buffer in the case of extremely high volumes of input documents. The conventional e-mail message 58, the Web Services Portal 61, and the FTP/File Receiver 68 could include document attachments of a variety of identified types.

If, for example, an image document 54 is transmitted as an electronic document 56 via a commercially available electronic facsimile service such as eFax.com, the eFAX document is e-mailed to an eFax portion 60 of the e-mail system. The e-mail transmission from e-Fax 60 is likewise a routed e-mail message, but is an “eFAX” e-mail having an image (TIF) attachment, as is offered by commercially available services. The e-mail with image attachment (60) is coupled to mail server 80. Such commercially available systems operate to receive a customer's fax via a telephone communication, package the fax as an e-mail and send the e-mail as directed.

Documents received via the Internet using the http(s) protocol are coupled via the Web Services Portal 61 to one of the system http(s) receivers 62, 64, or 66. Each of the http(s) receivers 62, 64, or 66 receives the electronic document transmitted via the http(s) protocol and packages the document as an e-mail transmission, which is then sent to e-mail system manager 78. Multiple http receivers are utilized under circumstances where a high volume of documents are being received, so that the system can efficiently process in parallel and at high speeds when required. The http(s) receivers 62, 64, 66 run, for example, on the IIS servers 18A, 18B, 18C shown in FIG. 3.

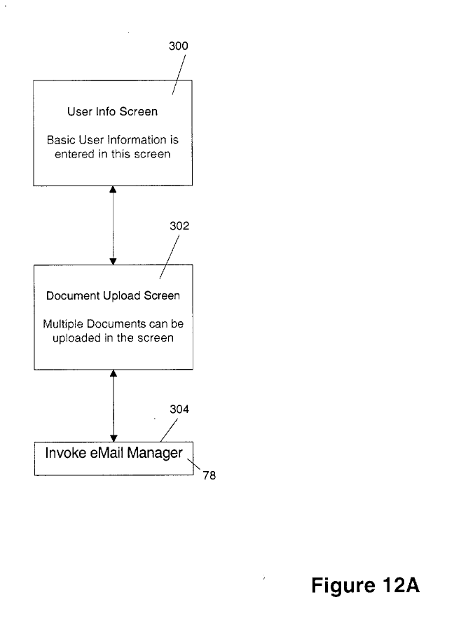

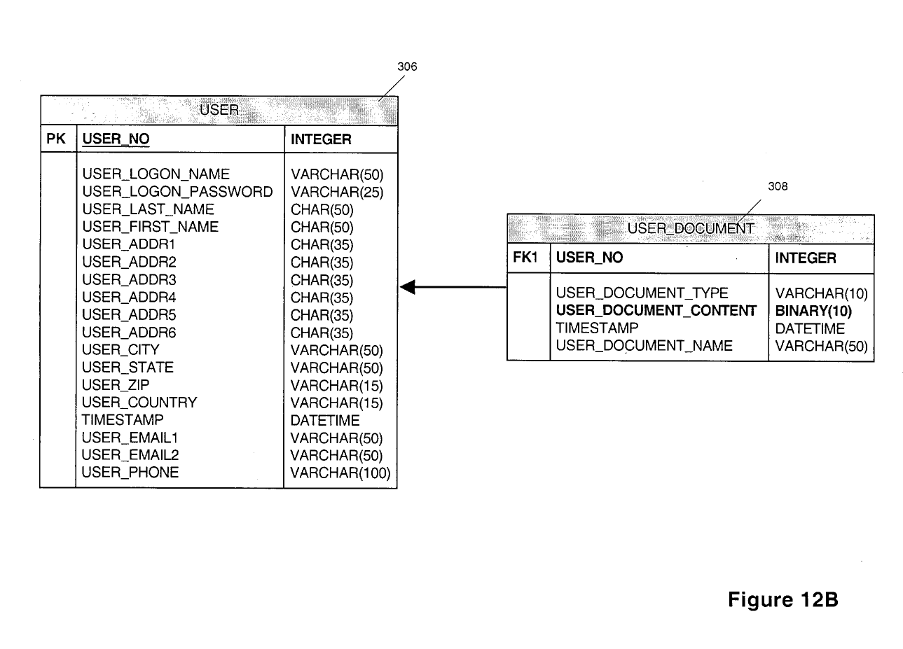

The http(s) receivers 62, 64 and 66 will now be described in further detail in conjunction with FIGS. 12A, 12B, 20 and 21. In accordance with an exemplary embodiment, http(s) receivers 62, 64, 66 have the capability of adding/uploading electronic documents such as Microsoft Word, PDF, XFORMS and images using http and http(s) secured protocol.

Using the user information screen (300) in FIG. 12A a user will be prompted to enter some basic personal information such as in FIG. 21 Document Group (404), First Name (406), Last Name (408), and email address (410) before uploading the document. There may be additional information captured such as Address and Phone number depending on the requirements. This user information will be stored in a user table 306 in the data base such as is shown in FIG. 12B.

The Document Group (404) selection is an exemplary embodiment that governs whether one or more documents comprise a “logical” grouping of documents to make a complete submission. The http(s) receivers 62, 64, or 66 will use the information that is defined in the System Setup (118) to prompt the user for all the required documents in a particular Document Group.

The user enters the system through a Web Services Portal, an exemplary embodiment of which is represented in FIG. 20. If the user desires to upload documents, the user depresses the “Upload Document” button (400). This will take the user to the document upload screen (302) in FIG. 12A and FIG. 21. Multiple documents can be uploaded at the same time using the upload function. In accordance with the exemplary embodiments, a wide range of features are contemplated. For example, a browse button (412) may be provided in the ASPX page for the user to browse electronic documents. The user can browse for files using the browse button and then click ‘Attach’ to upload the documents. A list box (418) may be provided to view all the files that are attached by the user. The user can then choose to remove some files in the list (416) if there has been a mistake made by the user. Some document types such as .vbs, .exe will be restricted to avoid any unknown file types or virus files getting into the system. The user presses the Submit (420) and the documents are then sent to the eMail Manager (78).

A confirmation email will be sent to the user after successful upload. If the upload of documents fails then the user will be shown an error message. This upload process is preferably automated using testing software like Load Runner to test uploading multiple documents without manual intervention.

As shown in FIG. 12B, documents that are uploaded will be stored in the User_document database table 308 temporarily and then the email receiver component 78 (FIG. 4) will be invoked as indicated at 304 in FIG. 12A. The documents that are stored in the table will be deleted after an email has been sent with all the attachments. The user will be provided a provision to enter from the address that will be passed to the email receiver component. This email address is a mandatory field.

A Submit button 420 will be provided in the form so that the user can click to send the documents that are uploaded. The “To email address” will be passed to the email receiver component. The “To email address” is stored in the ME System Parameter Meta data table by the http(s) receiver ASPX page.

Turning back to FIG. 4, a document may be received via the file transfer protocol FTP. A file receiver 68 receives such a document file and couples the document to the e-mail manager 78. The FTP protocol is a conventional protocol which operates to send batch files to desired destinations via the Internet or via a dialup modem.

The illustrative embodiments also contemplate receipt of documents via regular mail, which will be received at a physical mail station 70. The documents received by mail may, for example, then be scanned via optical scanner 76 and coupled to the e-mail manager 78. Alternatively, documents may be converted into an electronic document via a facsimile device 74 and forwarded to a fax server 72 which couples the electronic version of the document to the e-mail manager 78. The fax server 72 may likewise receive facsimile documents directly from an external fax device. The received facsimile documents are then coupled to e-mail manager 78.

In accordance with the illustrative exemplary embodiments, via the conversion of information received from http receivers 62, 64, or 66, FTP receiver 68 and scanned or faxed physical mail via 76, 74 and 72, the e-mail manager 78 ensures, along with the e-mail modules 58 and 60, that mail receiver 80 receives input from all sources in a common format, i.e., an e-mail with an attachment. Such an attachment may, for example, be a PDF, Word or image or any other document type. Through the use of mail servers 80, 88 which receive documents via attachments, the system operates to convert received documents into a desired standard document format on an “other than real time” basis. Thus, for applications where the standard documents must be processed as of a certain critical date, e.g., the due date for a government grant application or the due date for taxes to be submitted, the system will not be overrun by real time processing requirements resulting from the highly CPU intensive conversion process, which will be described below. In this fashion, the system may receive large numbers of e-mail communications per second, and later process the attached documents at a rate that the multi-channel engine can comfortably process. Mail server 80 may include a variety of mail servers, such a mail server 1 (82), which may be a Microsoft exchange server, or mail server 2 (84), which may be a Lotus Domino mail server. Additionally, server 80 may include other mail servers 3 (86). Additionally, mail server 80 may be replicated in the form of mail server system 88 to permit extremely high volume input processing. The mail servers 80 and 88 correspond to the FIG. 3 exchange servers 19A, 19B and further servers such as 19C are contemplated if needed.

The system also includes a mail queue listener/extractor 90 which is coupled to mail servers 1, 2 and 3 (82, 84 and 86). Mail queue listener/extractor 90 retrieves the mail and determines for each retrieved e-mail, the number of attachments that are associated therewith. The mail queue listener 90 will then retrieve each attached document and store the attached document in the relational database 110 associated with server 110 which may, for example, be an MS SQL server.

Where there are multiple attachments and multiple attachment types, each attachment type such as a Word document or an image document, is processed to handle unique issues associated with each document type. For example, a Word document will likely result in a 100% successful conversion to a standard format, whereas a PDF document would be slightly less than 100%, and an image document would be converted at a still lower success rate. If an image document is being processed such that the conversion cannot be successfully completed without intervention, due to an unreadable field, but the PDF and Word document could be successfully processed, the system operates to direct the image document to error processing. For example, the image document may be transmitted to document correction facility 127, where, using the client tools correction utility 126, the image document may be viewed and corrected. Documents which are required to be corrected may be appropriately stored in, for example, data base 110.

If independent documents are received which can be presented to the desired recipient immediately after conversion, the system will follow through on that course. The mail queue listener/extractor 90 applies predefined setup rules for delivering converted documents, e.g., delivering each attachment as converted or holding until all attachments are successfully converted and appropriately storing such attachments in the database 110.

The documents are retrieved from the database 110 and are forwarded to one or more multi-channel engines 92, 93. One or more multi-channel engines 92, 93 is utilized to manage the overall core document conversion process. In an exemplary embodiment, the multi-channel document conversion engines 92 and 93 are implemented by a combination of a conventional Microsoft Biztalk server 23A and the multi-channel engine server 24 shown in FIG. 3 and described in detail herein. The document router 102 shown in FIG. 4 is preferably implemented by a Biztalk server 23A.

The preferred multi-channel document conversion engines 92, 93 contemplates use of many different parsers. For example, the engines 92, 93 preferably include an image document parser, a Word document parser and a PDF parser and other types of document parsers.

The respective parsers in the multi-channel engines recognize that, for example, a purchase order has been received from a company A, which utilizes its own predetermined purchase order format, and transforms that company A purchase order format into a desired standard document form template purchase order in Extensible Markup Language (“XML”) format as represented in FIG. 4 at 96. XML is a vendor neutral industry standard language for creating self defining documents. XML lets users define and deliver data, type, and content. This makes it easier for devices and applications to search for, gather, and transport data. XML permits the intelligent presentation of data. With XML, embedded tags may be used to describe data, where the tags are user defined and identified as operational data elements. XML is transported over TCP/IP using HTTP, it is not limited to being presented in browsers; it can be delivered to other applications and databases for additional processing.

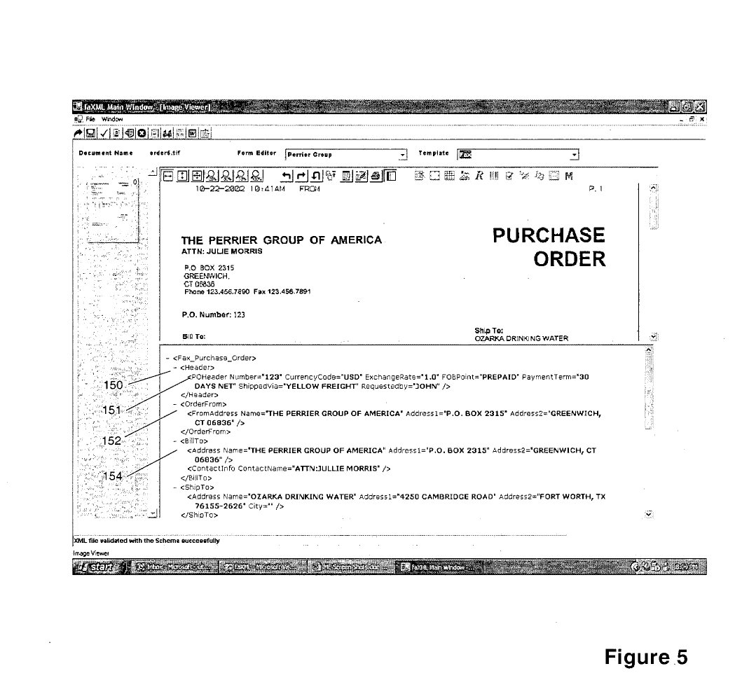

FIG. 5 shows an example of a purchase order in XML which defines, as can be seen at 150, a header field, followed by indicia identifying required form fields. For example, the XML document shown includes a “PO number” field 151, “order from” and “bill to” fields (152, 154) and many other fields as shown in FIG. 5. Thus, the definition of the document itself is embedded in the XML format. Such information is readable by both computer and human beings reviewing the form. An XML parser reads the fields within the carrot-like boundaries and appropriately processes the information contained therein.

Turning back to FIG. 4, the system includes a document router 102 for routing converted documents. The router 102 is coupled to a document management system 106. Final converted documents may be routed to document management system 106 for storage for future searching and later accessing of, for example, the original image and the converted document.

Converted documents are routed by document router 102 packaging it in a delivery form as requested by the target business application 104 which receives the converted document in its preferred format. For example, if the line of business application is a United States government grant application, the line of business application 104 delivers the information to a person within a particular entity, e.g., NIH, in the form required for the grant application.

Turning back to the multi-channel document conversion engine 92, the document conversion process involves mapping information from a user format form to a template for a standard document in accordance with conversion rules. For example, as part of the process of analyzing an input document, a determination may be made that a particular field is a date field requiring a pre-defined date format or an address field requiring alpha-numeric data of a predefined format.

The conversion process involves applying these conversion rules to the input original document. If the conversion rules require entry of data in a required field and the required information is not provided, then the converted form will not be supplied to the line of business application system 104, since presentation to such a system would result in error detection.

Under such circumstances, the document conversion engine 92 sends the partially converted form to the submitter via a notification and collaboration engine 108. Thus, notification and collaboration engine 108 provides required notifications to either the end user submitter of the form or other participants in the document conversion process.

The notification and collaboration engine also provides the ability, for example, for a user to add comments and or clarifications to the form. Then, for example, the user by interacting with the notification and collaboration engine may route the form to a second person for approval or additional comments. This concept is, for example, a “collaborative form” that dynamically takes on free form user information, embedding such information as history for future reference to changes made thereof.

An exemplary implementation of the Multi-Channel Document Conversion Engine (MDCE) 92, 93 will now be described in further detail. The MDCE receives document objects, associates them with preconfigured conversion templates or schemas, and generates machine readable data files as output. The MDCE is indifferent to the source document types, handling images generated by fax transmission, Adobe pdf, Microsoft Office (Word, Excel), XFORMS or any other rich document. The MDCE is, in an exemplary embodiment, built in a modular fashion such that any document type can be added as a standalone component.

In accordance with an exemplary embodiment, the MDCE runs in a transactional state, guaranteeing that when a document conversion process begins, it will either complete successfully, or be rolled back to its prior state. In the case of an error, the MDCE will send out notification alerts to previously defined administrators for their attention. In accordance with an exemplary embodiment, many different types of errors will be detected by the MDCE including those which are described specifically below.

The MDCE is built to be scalable, supporting both a horizontal and vertical hardware growth paradigm. Horizontal scalability entails having a farm of servers with each server doing individual parts. Vertical scalability entails parallel processing hardware configurations.

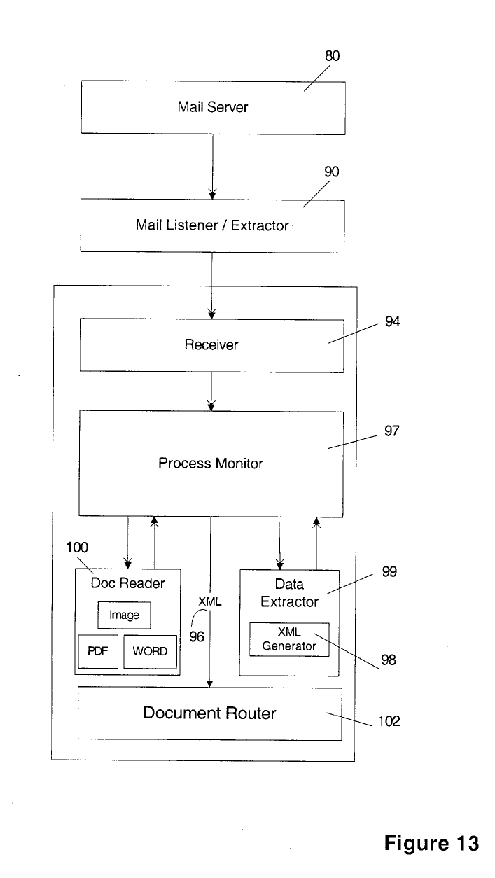

FIG. 13 illustrates the overall architectural design of this illustrative MDCE implementation. Components which are replicated from FIG. 4 are correspondingly labeled. The following six core elements to the MDCE are described below:

Mail Listener/Extractor 90

Receiver 94

Process Monitor 97

Document Reader 100

Data Extractor 99

Document Router 102

XML Generator 98.

The Mail Listener/Extractor 90 is the interface to the email system 80, which has been described above. The Extractor 90 is separated from the email system itself. There is no particular dependence upon a specific email system. The email system can be viewed as a large, temporary data buffer.

The Extractor 90 sets up what may be considered as a long running business transaction. If there are multiple attachments in the email, they may all be successfully processed, or one or more may fail conversion. The extractor 90 packages all the attachments into one business transaction and provides the set up to control the transaction.

1) Store Document Attachment in Database

The Extractor 90 receives an email with associated attachments. It strips the attachments from the email and stores them in the database as “blobs.” This is to insure document integrity. In the illustrative embodiment, the source document must not be changed to insure proper audit trail.

There may be more than one attachment existing in the email. The extractor 90 will properly remove all attachments.

2) Update Time and Process Status

When the attachments are first written to the data repository they are marked with a date and time timestamp and an initial status as Open

3) Store Mail Header Information

The email header information is stored in the data base as a part of the transaction package.

4) Change the Document Property to a Unique Identifier (Mail GUID _File Name)

A unique identifier is assigned to the transaction package for tracking and control purposes. Once this information is complete, the email is deleted from the e-mail system to reduce maintenance, overuse of disk, and automatic cleanup. In this exemplary embodiment, steps 1-4 are a “must complete” process and in the case that there is an error, the transaction is automatically rolled back and a notification of the error is sent.

Upon completion of this transaction, the Extractor 90 issues a delete to the email system and removes the e-mail.

5) Copy Attachments to Preconfigured File Folders

The Extractor 90 copies the attachments into a preconfigured system folder as defined in the setup configuration, by document type. All Microsoft Word documents are placed in one folder, PDF's in another, scanned images in another, etc. These folders are set up by the Infrastructure Control System Setup function.

End Process

Exception Handler for the Mail Extractor

In accordance with an exemplary embodiment, many different types of errors will be detected by the mail extractor 90 including the following:

Failure to connect to the SMTP Server

Failure to invoke Exchange Object Model methods

Runtime exceptions thrown by ASP or ASP.NET runtime engines

Failure to write the Folder under certain conditions.

Failure to query the database

Failure to stamp the document property with a new file name

Failure of mail property extraction

Scalability of the Mail Extractor component.

In this exemplary embodiment, the Mail Extractor component 90 supports the following functions

Activities have to be done inside a transactional context supporting the ACID properties of a typical transaction.

The Component should be scaleable to handle huge incoming loads on the SMTP server.

Scalability of the component could be addressed in the following ways:

Implementing a custom thread pool

Implementing Object Pooling under COM+ context.

Receiver 94

The receiver 94 performs the receive functions and reads each document from the designated file folder and passes the document to the Process Function. The number of concurrent threads which process requests targeted for a specific receive function is configurable. The receiver 94 functions are associated by document types and hence each document type can have a dedicated receive function.

Exception Handler for the Receive Function

In this exemplary embodiment, exception handling for the receive functions are handled by BizTalk Server and exception information is written out to the Windows System Log and BizTalk Suspended Queue.

BizTalk Server Scalabilty

Scalability of the BizTalk Server can be visualized in terms of horizontal scalability or vertical scalability. As previously described in part in conjunction with FIG. 3 horizontal scalability entails having a farm of BizTalk Servers with each server doing individual parts of Enterprise Document processing. Vertical scalability entails parallel processing hardware configurations for boosting the performance of the system.

Process Monitor 97

The process monitor 97 monitors the processing of each document and ensures the conversion to occur in a transactional context. The process monitor 97 performs the following operations:

Updates the Status Table with Document ID, Start and End Time

The Process Monitor 97 updates the timestamp when the document is selected and passes it to Document Reader (see Document Reader below).

After successful completion of processing by Document Reader, kickoff Data Extractor.

After successful completion of process by Data Extractor 99, the document has successfully been processed.

The Process Monitor 97 runs as a transaction insuring a “must complete” and “roll back” environment.

Pass the XML data stream to the configured channel.

Generic Exception Handler:

The system has a preconfigured folder for persisting documents which encountered errors during processing after BizTalk Receive function receives it. The documents will be persisted in the respective folders upon encountering errors.

A notification alert is sent out to the Administrator indicating the occurrence of processing failure with suitable hints to help out in taking corrective actions.

Document Reader 100

The Document Reader 100 is a configurable and extensible module that parses the supported document types. Based on the document extension, the Document Reader 100 kicks off the appropriate Document parser. Typical list of document parsers include Word Document parser, PDF Parser, image parser etc.

The appropriate document parser will have the intelligence built in to extract the individual document fields and values.

Ability to open and read the contents of the document

Extract information from the document as Name-Value pairs and post in the database

Update the Status table based on successful completion of the document

Return success or failure status information to the Process Monitor

Exception Handling for the Document Reader:

Invalid Word or PDF Versions present in the machine (e.g. lower versions of the product). Incompatibility between the Object Model present in the machine and the type of document passed to the engine (like passing Word 97 document to the engine)

Manipulating the Document Object Model (ex Word Object Model or PDF Object Model) may fail.

Identifying the correct document type (like 424, 424A, Company A Purchase Order) may fail

Database calls may fail

Custom exceptions thrown by the NET runtime.

Data Extractor 99

The function of the Data Extractor 99 is to convert the input document into the appropriate file structure as defined by the administrator in the Infrastructure Control System Setup function. There may be any number of format generators.

XML Generator 98

Read the content of the database for the given DocumentID

Transform the data to XML

Update the Status Table with the status of the processing

Return success or failure status information to the Process Monitor.

ASCII Generator

Comma Delimited, flat file, tab delimited LOB formats

EDI Generator

Exception Handler for the Data Extractor 99:

Handling Database Exceptions

Handling XML runtime errors coming out of the NET Runtimes when manipulating XML

Exceptions arising during the construction of the destination XML tree

Failure to communicate with router 102.

BizTalk Channel/Router 102

The BizTalk Channel 102 receives the data stream from the Process Monitor 97 and stores the document in the file system or routes to another BizTalk Channel for subsequent processing based on the setup.

Exception Handler for BizTalk Channel:

Errors arising out of BizTalk Channels will be handled by the BizTalk runtime.

Exception messages will be sent out to the Event Log and failed document processing will land up in the Suspended Queue.

Turning back to FIG. 4, the system also includes a user interface for the administrator of the process, which is represented in FIG. 4 by infrastructure control 116. A server administrator is the individual responsible for monitoring the operation of the system and for ensuring that the system operates as designed. The infrastructure control 116 includes an administrator's console 118 for system setup and an Infrastructure Monitor 120 which permits the administrator to discern information about the operation of all the components of the system shown in FIG. 4 including the various servers shown, such as the mail server 80, the servers associated with the multi-channel engines 92, 93, etc. The console will indicate whether each of the servers is up and running and whether each of the computers required in the document conversion process are operating properly. The system set up 118 permits the administrator to control trading partner setup operations and other functions appropriate for a system administrator.

The system also includes, in addition to infrastructure control 116, a template designer 123 for controlling the template design process and includes all the tools necessary in the ongoing document conversion process. In accordance with an exemplary embodiment, the template designer includes a template design module 124A, which controls a wide range of template design functions involved in the creation of templates, a template mapper 124B, which controls the process of transforming an original form fields to the proper zones on an appropriate standard document template, and a template manager 124C which manages the storage and retrieval of templates and sets up the required information for the “trading partners” referred to above. The operator of the template designer 123 will have more or less tools to manipulate depending upon the individual's associated access authority controlled by security/user role module 122 based, for example, on an analysis of the user's password.

A document correction facility 127 controls the viewing and correcting of documents in which errors have been detected. The rules for accepting or detecting a document will vary in accordance with the application. For example, in a business purchase order context, the system operates to avoid rejecting orders to purchase products whenever possible. The document correction utility 127 permits on-line correction during the document conversion process resulting, for example, from an inability to read data from an original form from a customer. When detection of a document conversion failure occurs, documents are forwarded to the document correction utility 127 and dependent upon the form of a document are delivered either to a Word correction utility, a PDF correction utility or fax/image correction utility embodied in correction utility 126. With respect to each document type, the original document is displayed in one window and the attempted conversion in a second window, thereby enabling a user to identify the error and make appropriate correction where possible. The correction utility uses available correction tools associated with each document type. For example, a Microsoft Word document editor may be utilized for Word document editing and a Microsoft Biztalk screen editor 244 may be utilized during the editor/viewer association process. The Microsoft Biztalk Mapping and Microsoft Biztalk Schema Editor may be utilized for handling errors during the document mapping process, where, for example, a source document is converted into the XML format as described above. With respect to PDF document correction, the Adobe Acrobat editor may be utilized. Similarly fax/image corrections may be made using a commercially available OCR engine such as the Scansoft OCR engine.

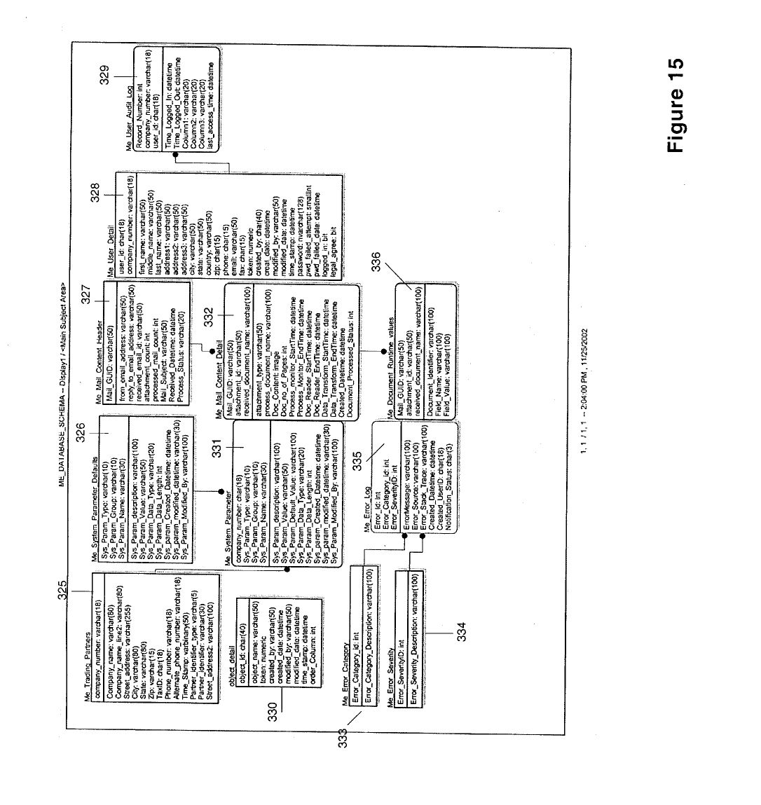

The system includes relational database 110 which, for example, stores all setup information including all the trading partner definitions, the original document transformation information, templates, the images that have been transmitted by form submitters and the resulting XML that was generated. The relational data base also stores meta data 112. In accordance with an exemplary embodiment described below in conjunction with FIG. 15, the meta data will include:

Document Name

Document Type

Timestamp of each of the processing steps

Initial receipt

Document conversion

Error processing.

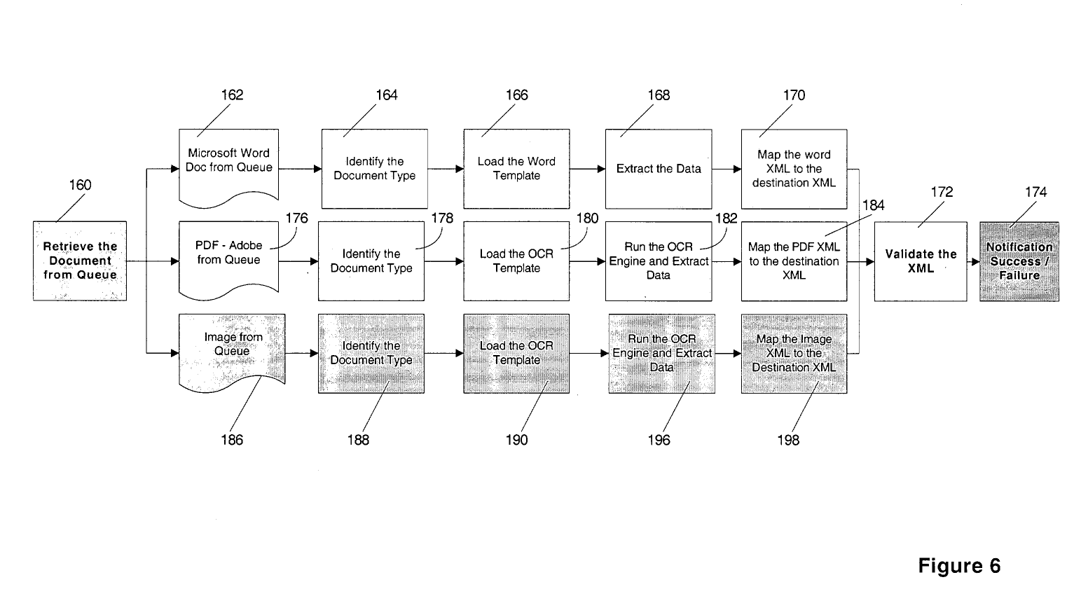

FIG. 6 is a work flow diagram delineating the sequence of operations performed in the multi-channel engine 92 during the document conversion process. As shown in FIG. 6, a document is retrieved by the mail queue listener/extractor 90 shown in FIG. 4, from the mail queue. A determination is made whether the document retrieved from the queue is, for example, a Microsoft Word document, a PDF-Adobe document or an image document and is directed to an appropriate processing sequence depending upon the document type detected. The document type may be identified in a variety of ways. For example, the document may be compared to a known document type template thereby resulting in document type identification.

If a Microsoft Word document is obtained from the queue (162), an identification is made that the document type is a Microsoft Word type document (164). Thereafter, the Word template that had been created in the template designer 123 is loaded (166). Based on the template received, the required data elements are identified, and the identified data elements are extracted from, for example, the original purchase order form submitted by a company seeking to purchase goods or services (168). The extracted data is then placed in a Word XML format and is then mapped into the standard document template in XML (170). Thereafter, the destination XML is validated to make sure all the fields such as the date field, numeric fields, etc. are correct (172). Finally, the notification of success/failure is generated (174), which is then delivered to the submitter.

If a PDF/Adobe document is retrieved from the mail queue (176), the PDF/Adobe document is identified (178). An optical scanning engine may be used to scan the PDF document obtained via the e-mail attachment or some other data extraction technique may be used. An OCR template appropriate for the PDF document is then loaded (180) or the appropriate data extraction tool is loaded. Thereafter, the OCR engine or the data extraction tool runs to extract data from the original PDF document. A PDF-XML document is generated and mapped to a destination standard XML document (184). Thereafter, as indicated above, validation and notification processes are performed (172, 174).

With respect to facsimile documents, as indicated above, one mode for receiving a faxed document is via a commercially available eFAX service. Under such circumstances, a corporate customer service representative may provide end user trading partners with a phone number for sending facsimile transmitted purchase orders. Under such circumstances, a retrieved image from the queue (186) will be recognized as a facsimile purchase order (188). Thereafter, an OCR template is loaded for eFAX transmissions (190).

The OCR engine is then run. As the document is being scanned, known zones on the scanned facsimile are identified and data is extracted (196). An image-XML document is generated and mapped to a destination standard XML document (198). Thereafter, as indicated above, validation and notification processes are performed (172, 174). If the OCR engine is scanning, for example, a known date field, the software may be designed to generate an indication of the probability of a successful read of an identified zone. Depending upon the criticality of a particular field, a high probably of success, e.g., greater than 98% may be interpreted as a successful read. A probability below the selected value will result in an error being detected and the erroneous field highlighted.

In case of detected errors, the document correction facility 127 (FIG. 4) permits corrections to be made to correct, for example, apparent problems, at which time the form may be resubmitted for conversion. Thereafter, an image XML is generated which is then mapped to the destination XML (198).

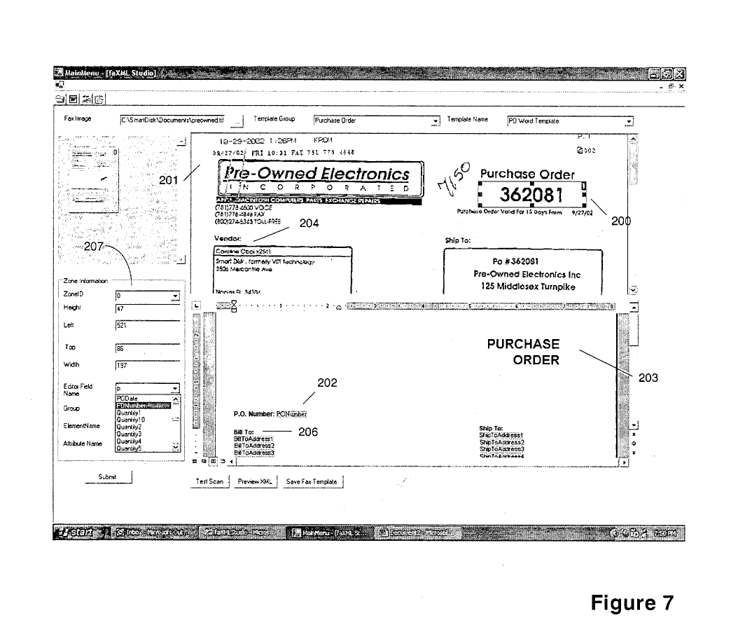

FIG. 7 shows an exemplary screen display depicting an image document in the form of a customer's original purchase order 201 in the process of being mapped to a template standard document purchase order 203. The OCR scanning engine identifies a PO number zone 200, in original customer purchase order form which, in the example shown in FIG. 7, contains the numeral “362081.” This customer format purchase order number zone 200 is mapped to the standard document purchase order number zone 202 on the standard document purchase order template 203 shown in the lower portion of FIG. 7.

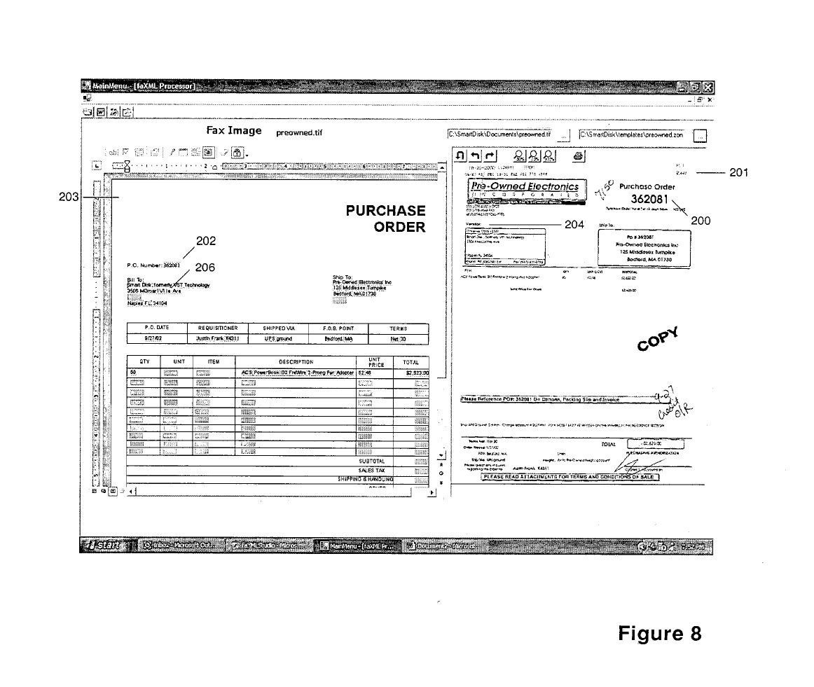

FIG. 8 is a screen display which shows the data extracted from the customer's purchase order form 201 and inserted into the standard document purchase order template 203. Note that, for example, the purchase order number in field 200 of the customer form 201 has been inserted into the purchase order number field 202 in the template document 203 as shown in FIG. 8. Similarly, the “bill to” field in the customer's purchase order 201 has been extracted from the customer purchase order field 204 and inserted into the purchase order template field 206. All the fields in the left window of FIG. 8 are editable.

When the purchase order standard document template fields have been completed, the fields are inserted into an output document XML, as shown in FIG. 5. See, for example, the purchase order number field 151 which has been populated with “123”.

In accordance with an exemplary embodiment, various operator prompting approaches may be utilized to, for example, lead an operator through the document mapping process. In FIG. 7 the selected fields are highlighted and the relative position of the field on the source document is displayed in the zone information 207. All the fields in the, for example, customer's purchase order form such as 200, 204, etc. are identified as the location from which data must be extracted and mapped to the purchase order standard document template shown in the bottom portion of FIG. 7 and the left pane in FIG. 8.

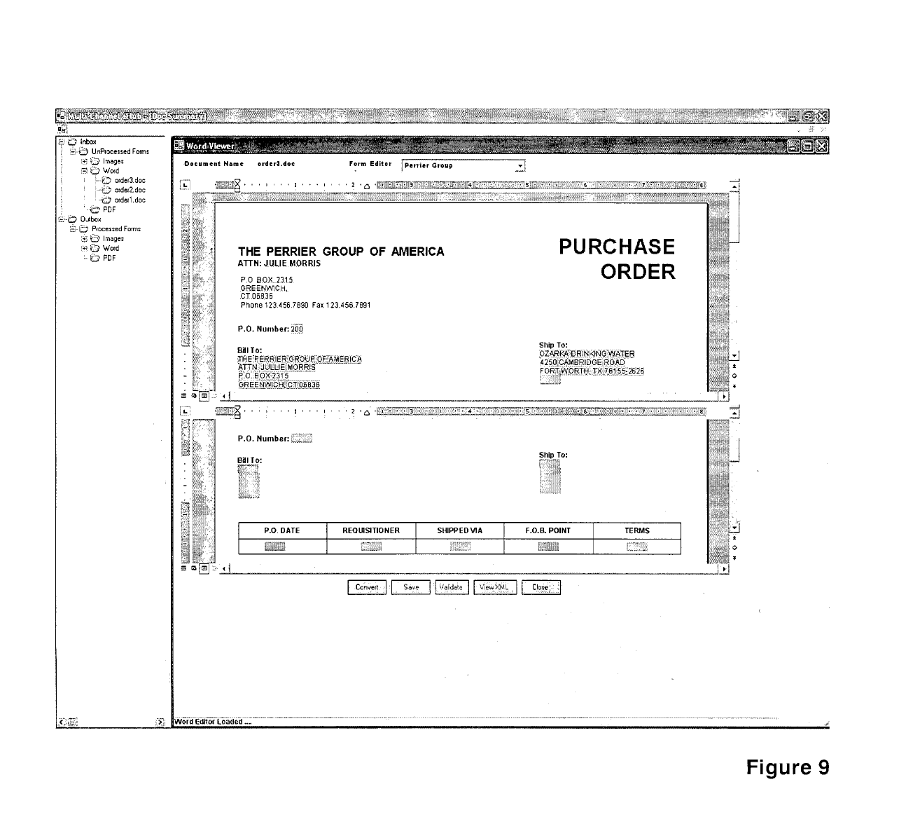

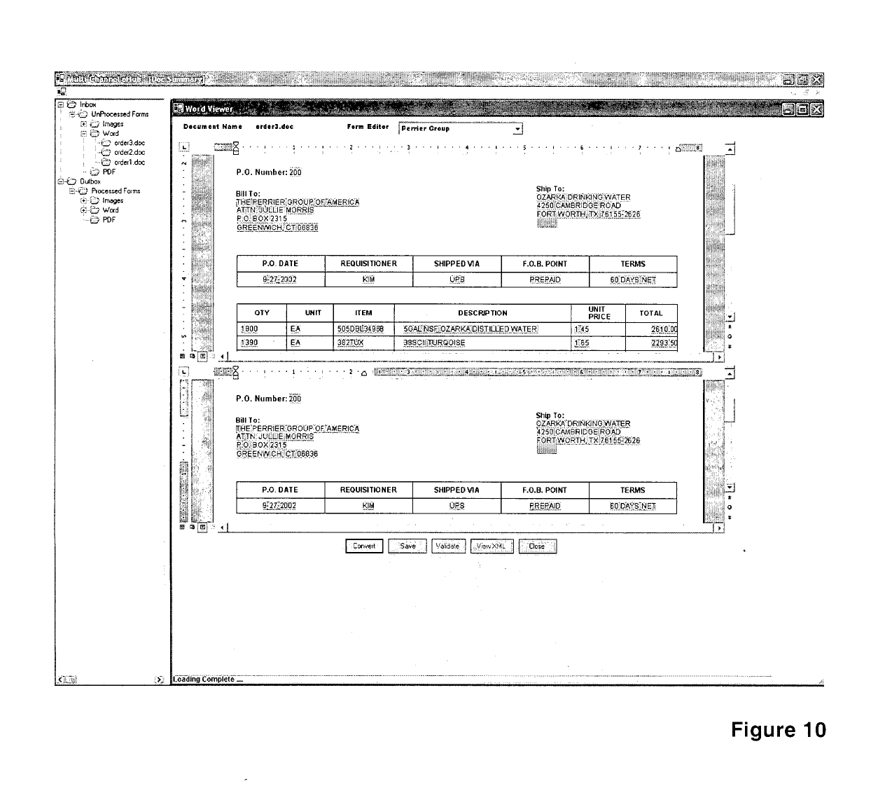

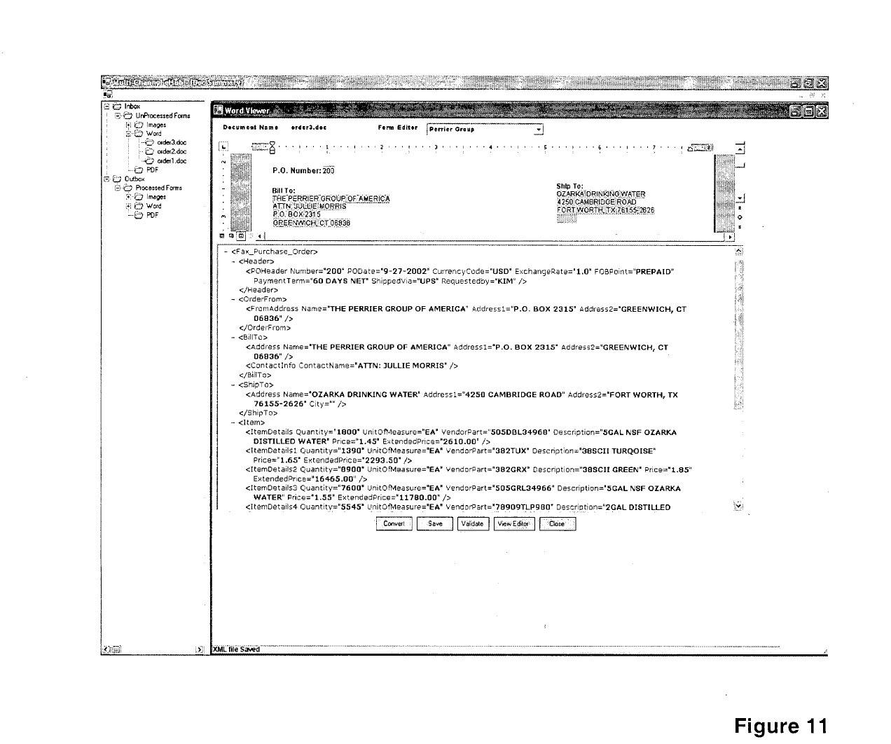

FIGS. 9, 10, and 11 are screen displays showing purchase orders for Word-type documents, rather than the image type documents of FIGS. 5, 7 and FIG. 8. FIG. 9 shows a customer purchase order in Word format and the counterpart standard document Word purchase order template. FIG. 10 is the word type document counterpart to FIG. 8 described above, wherein the extracted data from the customer Word type document is inserted into the template document and FIG. 11 is the counterpart output XML document to the previously described FIG. 5. With respect to FIGS. 9 and 10, the zoning related data referred to above with regard to an image type document are not utilized in processing Word type documents, because the data from the Word purchase order had previously been associated with the Word template during template setup operations. In the template setup operations for a Word document the digital data is already present in the Word document, whereas in the image document processing, a document is typically scanned as part of the document conversion process.

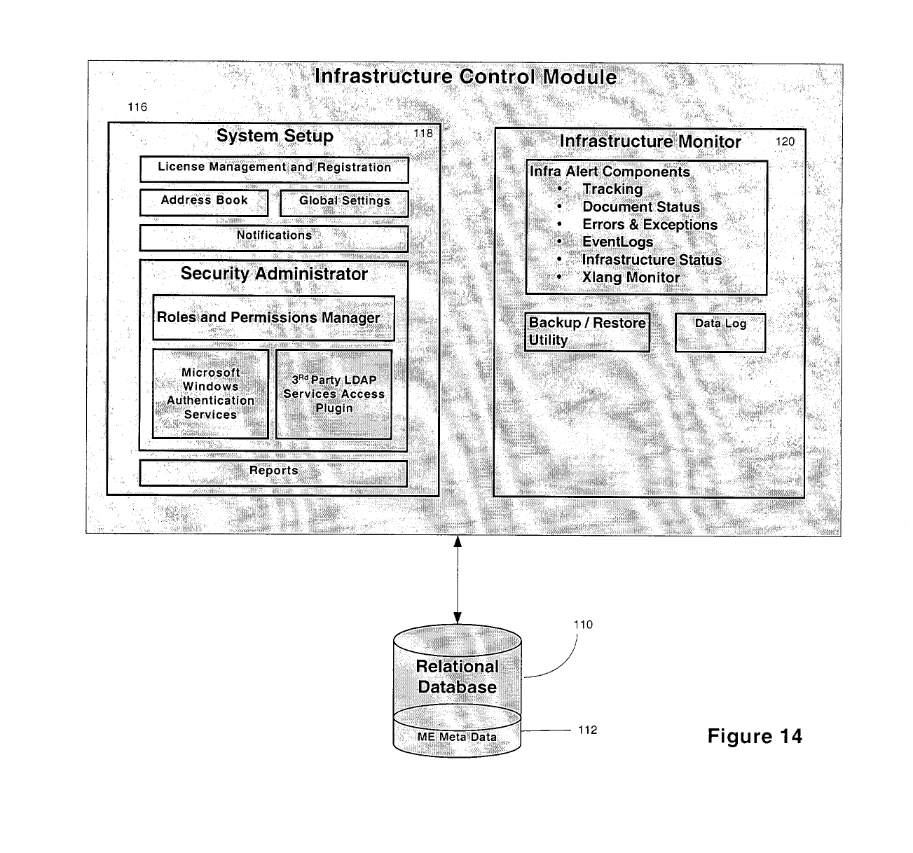

FIG. 14 is a block diagram of an exemplary implementation of the infrastructure control module. The Infrastructure Control Module 116 shown in FIG. 14 is a browser-based user interface that allows an administrator to set up the basic production environment of system described herein. In an exemplary implementation, it is not involved in the actual workflow of receiving and correcting rich documents or images. That is the role of the Document Correction Module 127.

The typical user of the Infrastructure Control Module (hereinafter ICM) 116 is the IT professional of a production site. The browser-based approach allows for access from anywhere in the network, making it easier to monitor the production environment.

In accordance with an exemplary embodiment, key components of the ICM 116 are System Setup 118 and Infrastructure Monitor 120 shown in FIG. 14.

System Setup

The system setup 118, in accordance with an exemplary embodiment, includes the following system components shown in FIG. 14:

License Management and Registration

License management and registration controls the actual feature set of the system described herein. It uses the commercially available license management software an example of which is Sentinel LM from Rainbow Technologies. Some basic registration information will come from the, for example, InstallShield installation process. This function will allow maintenance of the information that is initially gathered during the installation process as well as capturing additional information. In accordance with an exemplary embodiment, the key functions are:

Manage feature set of the product based upon registration key

Features are on/off

Key's by CPU

Number of client seats

Manage the basic customer information such as

Company Name

Address

Phone Number

Primary Contact—Business

Primary Contact—Technical

“About” function for all modules

Address Book

Depending upon the implementation, there may be a need to capture the basic contact information for trading partners. The address book takes the normal registration information such as:

Company Name

Company Address

Contact Information

Phone Number

Fax Number

eFax Number

There is provision to handle multiple addresses as well. These addresses may be used in other accelerator applications. Examples are:

Multiple “Bill To” addresses

Multiple “Ship To” addresses

Multiple “Ship From” addresses

A delineation of the role of the trading partner (Customer/Buyer or Supplier)

Global Settings

The Global Setting function holds system-wide settings that influence the manner in which the system described herein operates. The Global Setting module includes, for example:

Language Translator

Identity control such as:

Company Logos

UI Look and Feel

Scalability Settings

Number of concurrent threads

CPU Affinity Selection

Email Settings

What is the email system API in effect

Document Repository

What is the Document Management System in effect

Default Server (SQL Server, see Reports below)

What Content Server is in effect, such as:

Microsoft SharePoint Server

Documentum

Microsoft Content Server

Notifications

The notifications module can be set for different events within the system. The system is based upon roles (See Security Administrator). Various notifications will be generated by the system automatically based upon these roles. The notifications can be selected (on/off), and also be sent, for example, via email or fax.

Security Administrator

System security is provided in part via the security administrator module. In accordance with the illustrated exemplary embodiment, the system includes a SQL based security module which filters data stored in the system database and controls access to the database based on a roles and permissions manager subsystem, which limits access based upon the identity and pin number of individuals in a role-based logon analysis. The roles and permission's manager allows access to various features sets depending upon assigned roles and access authority of those who sign on. In accordance with an exemplary embodiment, the security administrator module controls access to various aspects of the system.

Roles Manager

Supported roles are:

Administrator (ICM Module Access)

Template Designer and Publisher

Document Correction

Permissions Manager

Add, modify and delete ID's

Reset Passwords

Directory Interface—The permissions manager will provide a default permissions capability using SQL Server permissions. However, in the case where there is another directory service available, for example LDAP, that service may be used instead.

Active Directory

LDAP

Reports

The reporting utility generates any of a wide range of reports regarding system operation. In an exemplary embodiment, the reporting utility will identify what has been processed in a given period of time. A report as to how the parameters have been set, how trading partners (customers) have been set up and mapped and any of a wide range of reports to enable the system administrator to monitor through put and analyze system operability. The reporting utility would include a query and search utility which may be implemented using any of a wide range of searching tools, including a full text searching capable.

In an exemplary embodiment, report generation and searching functions may utilize final document repository 110. The repository stores the original, unchanged document along with meta data 112 about the document. The meta data 112 will include:

Document Name

Document Type

Timestamp of each of the processing steps

Initial receipt

Document conversion

Error processing.

The repository will also hold the converted XML output as a result of an image scan or rich document data conversion.

The SQL Server provided as a default allows simple searching based upon the meta data of the document, or the text that is available in the converted XML.

This basic searching function will be available to all the user interface roles.

As described above in conjunction with FIG. 4, there may be a document management repository 106, such as Documentum or SharePoint, deployed as part of the overall solution. In the case of such, the Document Router 102 will make the original document and converted XML available via a standard API. All the document management and searching capability of these systems will therefore be available to the customer. The “out-of-the-box” document management capability of the Document Conversion Engine is not attempting to provide a complete document management function. It is intended as a basic function only, and if the customer wants more sophistication, use a third party product.

In accordance with an exemplary embodiment, the following default HTML reports will be available:

Document Count by type (Rich Doc, Image, etc)

Successfully converted

Errors

Document Service Level

From time of receipt to time of conversion

Date selected

Document Template Report

Document Zone Report

Trading Partner Report

Document types by template and zone

Infrastructure Monitor 120

The Infrastructure Monitor 120 of FIG. 14 manages the “heartbeat” of the system described herein. It monitors all the infrastructure components necessary for this system to properly function. The infrastructure monitor's purpose is to provide a fast way to provide monitoring without having to utilize a complex third party tool. It is focused on the significant infrastructure elements.

In accordance with an exemplary embodiment, the infrastructure that is monitored includes both physical components like the IIS Server, the SQL Server, the Application Server; and logical components such as the internal BizTalk queues, XLANG schedule, etc.

Since the monitor is browser-based, it allows the administrator to check the components without leaving his desk. There is also a notification process that will send out an email or page.

Infra Alert

In accordance with an exemplary embodiment, the Infra Alert module shown in FIG. 14 is a web-based monitoring tool used to check on important Microsoft services. These services include:

Microsoft Internet Information Server (IIS),

BizTalk Server,

Microsoft Message Queue (MSMQ),

File Transfer Protocol (FTP), and

Simple Mail Transfer Protocol (SMTP).

The Infra Alert module shown in FIG. 14 provides a management console that can be used to monitor multiple servers and services.

The Infra Alert module provides a view of the status of each service running on a server. It searches for these services and displays their status as available or not available. A user can also enable or disable BizTalk services remotely from the management console over the Web. Infra Alert also allows a user to look at the event logs to identify any errors originating from any service. Moreover, Infra Alert can send a proactive alert notification by e-mail about any service failures.

In accordance with an exemplary embodiment, Infra Alert includes a comprehensive context sensitive Online Help Center. Click on Help from any screen displays the Help documents relevant to that screen together with a clear explanation. Infra Alert enables a user to observe the performance and increase the reliability of the infrastructure with powerful, flexible and easy-to-use management and monitoring services.

Infra Alert includes the following modules:

View: Provides a quick visual check of the status of the infrastructure servers. It displays a list of critical services and the name of the server on which the service is running. It lists the status as either “available” or “not available”.

Configure: This provides the options to configure and manage

Contact Info,

Services,

Event Log,

Notifications,

Profile.

Event Log: Displays the Application, Security, and Systems logs recorded in the Windows event log on the server. Event Logs track significant errors that occur in the system or application. Infra Alert provides notification of these events to designated users.

Suspended Document: Displays the details of each document that has not been parsed, transmitted or processed by a BizTalk server.

View

Infra Alert searches for the configured services in their corresponding servers and displays whether they are available on the network or not. If some services have not been started, or have errors, they will be shown as not available. This screen displays the following:

Infrastructure Services: The Infrastructure Services section displays:

Services: Displays all the services that are required to manage the infrastructure.

Server: Displays the names of servers where each service is present.

Status: Displays “Available” if the service is found and running on the specified server. Else, the user will see [symbol] Not Available icon which means the service is not started or not working.

BizTalk Receive Services: The BizTalk Receive Services displays the following:

Name: While configuring, if the user selected BizTalk Receive Services, then all the names of receive functions in the BizTalk server will be displayed. If the user wants to see the configuration of a service, the user clicks on the name of the receive service. This will launch the Receive Function Details screen. The Receive Function Details include the group name, comments, file mask, processing server, proto type, polling location, password, user name, document names and source ID.

Current Status: If the receive function is enabled, the status displays Enabled. Else the user will see Disabled (0) [symbol] . Next to the Enabled or Disabled status, the user will see a number enclosed in parentheses. This number is a hyperlink and it displays the number of files under the receive function's polling location. For example, Enabled (2) means that 2 files are under the receive function's polling location. If the number of files exceeds that count specified in configured Maximum Count of Unprocessed Files, then a warning icon [symbol] is displayed. Click on the warning icon and a list of file names will be displayed.

Update Status: The user can change the current status of the receive function from enabled to disabled or vice versa. If the Current Status displays Enabled for a particular receive function, the Update Status for the same receive function will display the Disable button. If the user wants to change the current status on a particular receive function to disable, simply click on the Disable button. Now the receive function will be disabled.

Configure

In accordance with an exemplary embodiment, the user can configure or set the following:

Contact Info—Allows the user to configure/set the technical support contact details in this screen. This contact information is displayed in all the notifications that are sent.

Services—This function allows the user to configure the services that are required for his specific infrastructure. (The user can assign the services to their corresponding servers.)

The following services are available to be assigned to servers:

Internet Access

Internet Information Server (IIS)

BizTalk Server (for IIS)

Message Queue Server (MSMQ)

SQL Server

File Transfer Protocol Server (FTP)

Mail Server (SMTP)

BizTalk Receive Services

Maximum Count of Unprocessed Files

Admin Server

Event Log—An event log is a recording of any significant errors or events in the system or the application. Event Logs are classified into the following categories:

Application: An application event log is generated if any significant events occur in an application that is hosted in the system.

Security: A security event log is generated if there is a breach of security or security related errors within the system.

System: A system event log is generated if any significant events occur in the operating system.

The events that are generated in the Event Log are gathered and e-mailed to the technical support personnel.

Notifications—This function is used to set/configure delivery mail ids for reporting document or service failures.

Profile—The user can use this screen to change the personal profiles.

Event Log

An event is any significant error in the system or in an application that requires users to be notified. For critical events such as Service Control Manager (Service is not responding to control function), a message will appear on the screen. For many other events that do not require immediate attention, the operating system adds information to an event log file to provide information without disturbing the user's work. This event logging service starts each time the system is started.

You can see the event logs (if any) of:

FTP Server,

BTS Server,

MSMQ Server,

SQL Server or

IIS Server.

Event Log Filters

Events that are generated could be large in number. In order to narrow the event log view, you can set event log filters. The events can be filtered by the following categories of importance:

Error: A significant problem, such as loss of data or loss of functionality. For example, if a service fails to load during startup, an error will be logged.

Warning: An event that is not necessarily significant, but may indicate a possible future problem. For example, when disk space is low, a warning will be logged.

Information: An event that describes the successful operation of an application, driver, or service. For example, when a network driver loads successfully, an Information event will be logged.

Success Audit: An audited security access attempt that succeeds. For example, a user's successful attempt to log on the system will be logged as a Success Audit event.

Failure Audit: An audited security access attempt that fails. For example, if a user tries to access a network drive and fails, the attempt will be logged as a Failure Audit event.

Suspended Documents

Suspended Documents are documents that the BiztTalk server was unable to process. Once a document is submitted to the BizTalk Server, the BizTalk server's receive function picks up the document, parses it and converts it to XML or some other format. Occasionally, the document goes into the suspended queue. BizTalk will retry processing the document, but if it fails, it is sent to the suspended queue and reported in suspended documents.

When you select suspended documents, the screen displays all the suspended documents found. Some of the conditions that cause a document to become suspended are:

It is not in the specified format

The processing components are not properly registered

If any infrastructure error occurs.

The suspended document page displays the reasons for the failure and a list of the documents that were not processed.

Backup/Restore Utility

The backup/restore utility interfaces with the standard Microsoft backup/restore function and sets a schedule.

Data Log

Certain events will be logged for future reporting and recovery. Documents, templates, Zones, XML conversions, addresses, etc. may be deleted from the data base. These deletes will be “soft deletes”. As such, the Data Log function allows for a final purge of deleted objects, or a recovery of same.

FIG. 15 is a block diagram depicting an exemplary set of tables forming part of the data base 110 shown in FIG. 2. It should be understood that the present invention contemplates storing additional data and other data storage arrangements beyond what is expressly depicted and that the table configuration shown in FIG. 15 is by way of example only. The linked tables shown in FIG. 15 store data that is largely self-explanatory, which will not be described in detail herein. Many of the various data base tables include date/time/timestamp related to establish, for example, the point in time when a document was received and/or created.

The data base 110 includes a trading partner table 325, a system parameter default table 326 and a system parameter table 331 which is linked to the system parameter default table 326 and the trading partner table 325. The data base also includes a mail content header table 327 and an associated mail content detail table 332, which is linked to a document runtime values table 336. A user detail table 328 and a user audit log 329 are also included in the data base 110. A table 330 stores detailed object (e.g., document object) information. Additionally, the data base includes error related tables such as the error category table 333, the error severity table 334 and the error log table 335.

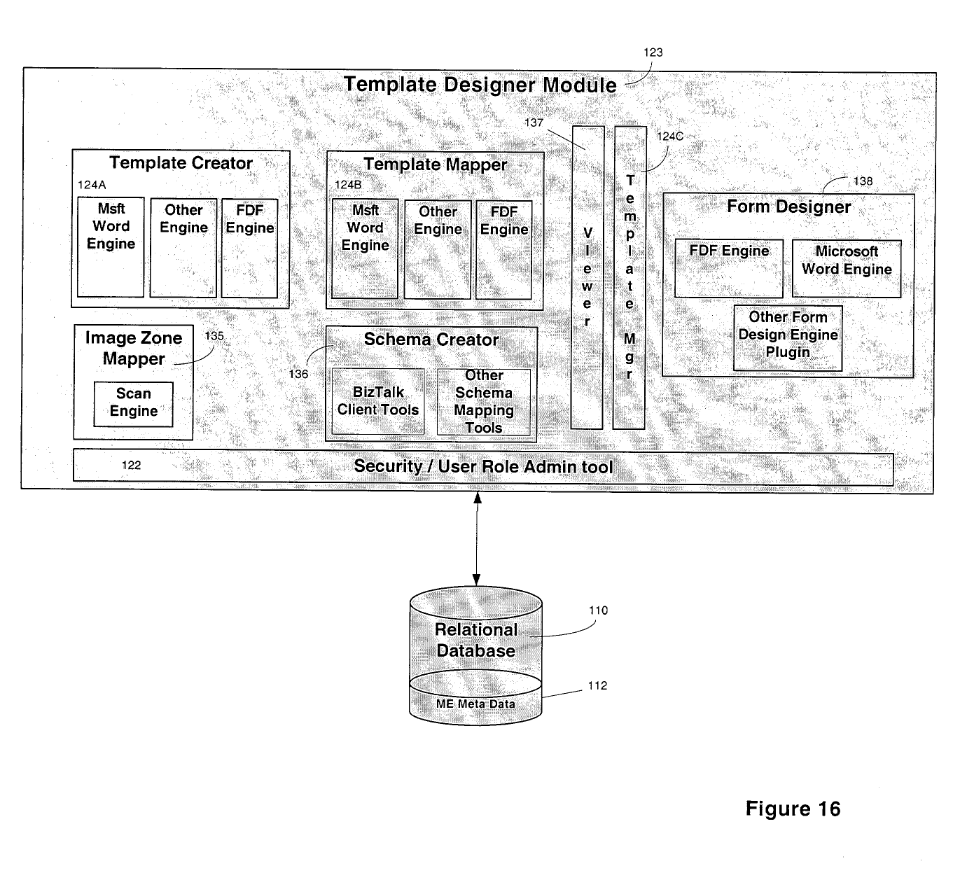

FIG. 16 is a block diagram depicting an exemplary implementation of the template designer 123 shown in FIG. 4. The Template Designer (TDM) is a client based product used by the form design administrator to produce the necessary information for the Multi Channel Document Conversion Engine to properly convert incoming documents into a data format usable by a “Line of Business” (LOB) application.

The TDM 123 can be used to author new forms, create forms templates for existing forms, create image zones that tie to the templates to faxes, and produce the format for the final data layout that is used by the LOB application.

The Document Conversion Engine 92, 93 shown in FIG. 4 uses the following document information in its operation:

A Document

A Template that describes the Document

If the Document is an image, a Zone Map

Zone data semantics

A mapping of the incoming document to the template, either using the zones or the fields themselves

Definition of the format needed by the LOB application.

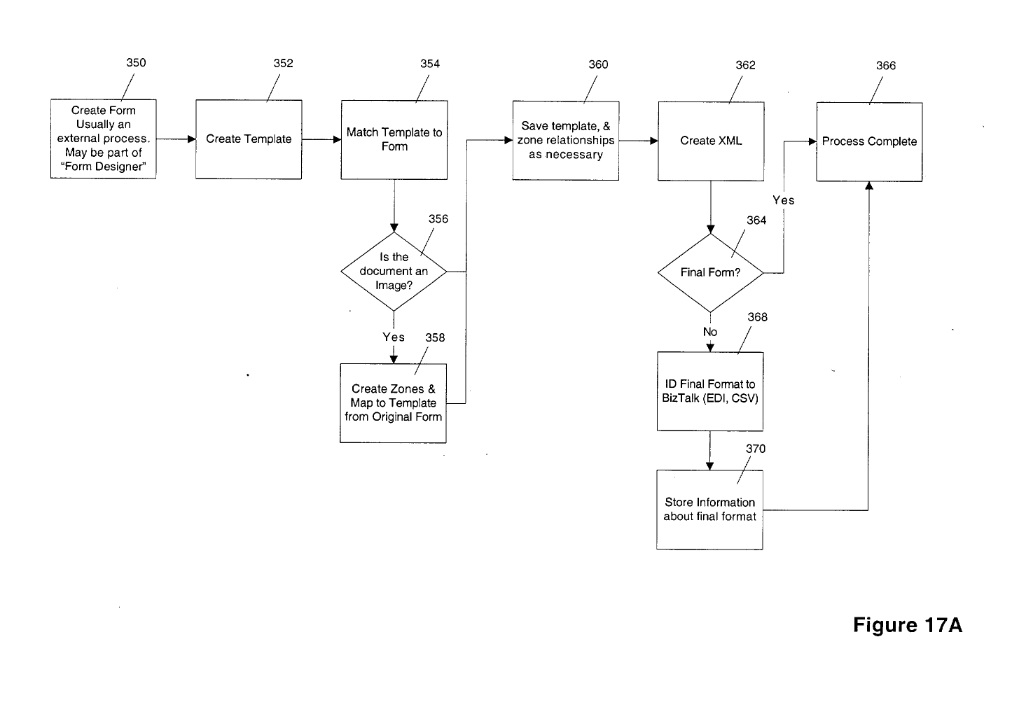

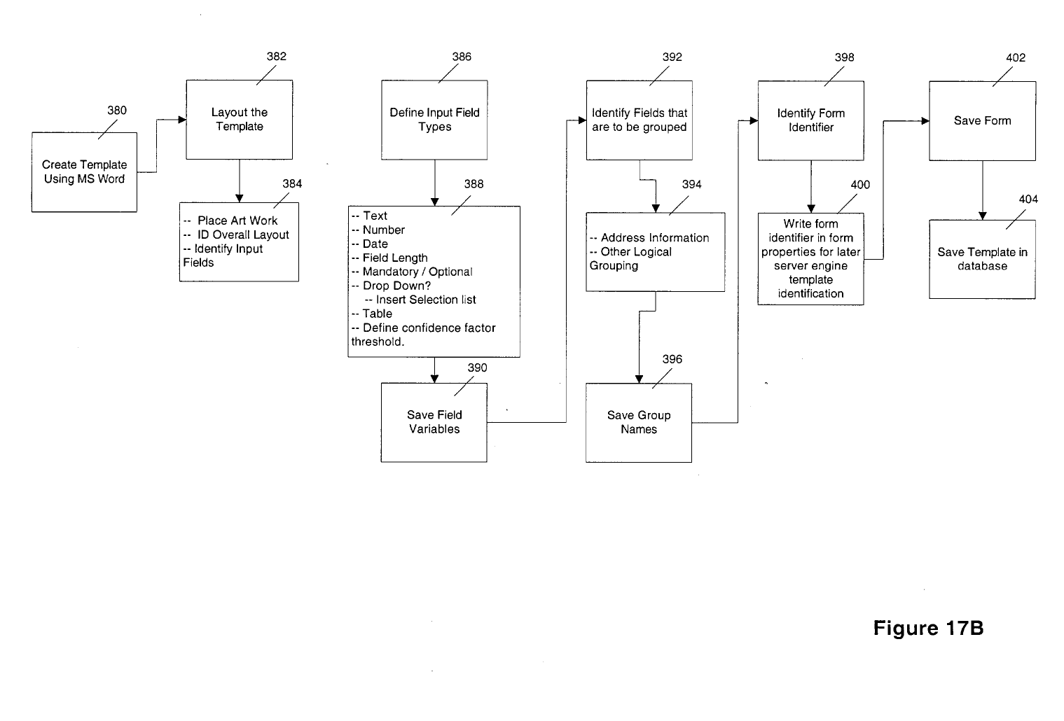

FIGS. 17A and 17B are examples of a work flow delineating sequences of operations relating to the template design process. Turning first to FIG. 17A, the business process demands that some kind of form (350) is to be used to gather information. Examples of forms are Purchase Orders, Invoices, Grant Applications, or anything that has a prescribed format for submission. Typically, there will be a person who designs the forms. The form itself may be created using any tool.

Once there is a form and an identified need to capture the variable information from the form for processing by some computer application, the solution in the exemplary embodiments comes into play.

The document conversion engine must know how to interpret the fields in the form. A “Template” is used to describe the form (352). In an exemplary embodiment, the engine then must associate the incoming form with the proper template (354).

If the document is an image document resulting in a scanned image (356), it must be “zoned” so the scan engine can find the variable fields in the form (358, 360).

The default output of the engine is a XML (neutral) format (362). This may or may not be compatible with the LOB application. Therefore, the last step is to define the file format that is required for the LOB application (364, 366, 368, 370).

Turning back to FIG. 16, a Form Designer 138 may be used to provide a step by step wizard for proper forms creation. If the user doesn't have a form, and has the ability to influence the form submitter in what exact form to use, then the Form Designer (FD) is the tool to use.

The FD launches Microsoft Word, Adobe Acrobat or some other form design tool within a controlled environment and provides a tool set that prompts the forms designer in the creation of the property information on all the fields. It also captures property information about the form itself for delivery to the engine.

Finally, it asks if this is also valid as a template. If so, a template file is created that may be used for conversion by the engine.

The form is then saved into the data base and controlled by the Template Manager 124C.

Template Creator (TC)

The Template Creator (TC) 124A is the component that leads the user through the creation of a template. The template will define the variable fields that are expected, the characteristics of each field, and whether the fields are mandatory. The TC module 124A is also used as the core engine for the Form Designer. In accordance with an exemplary embodiment, versions may launch different form creation engines such as Adobe's Acrobat Forms product, Microsoft Word, or any other form design tool.

FIG. 17B shows an exemplary sequence of work flow operations performed by the template creator 124A. The TC launches the appropriate plug in as the core template engine. The work flow diagram of FIG. 17B shows an exemplary sequence of operations performed during the template creation process. The TC 124A will lead the user through the creation of the variable fields and properties of the fields as shown in FIG. 17B. In an exemplary implementation the template will be created using MS Word (380). The system will prompt the user to layout the template (382) by placing the art work, designing the overall layout and identifying input fields (384). The input fields will be defined (386), for example, in accordance with the exemplary specifications shown at 388. The variable fields are then saved (390) and the fields that are to be grouped are identified (392, 394). The group names are then saved (396). A form identifier is then identified (398) and written into the form properties for later use in template identification (400). The form and the template are then saved (402, 404).

Template Mapper (TM)

Turning back to FIG. 16, the Template Mapper 124B operates to connect the fields from the incoming form to the template. It is possible to have many versions of a form as input. For example, there may be many types and layouts of a Purchase Order, but there need be only one template for translating them. As long as the template is a superset of the information that would come from all Purchase Orders, there is no need to produce more than one template.

The mapping function allows the user to take each version of an incoming document type (such as Purchase Order), and make a field-by-field connection to the common template.

Each template map, which is unique for each trading partner, will be saved as an association with the source document.

The Document Conversion Engine 92 uses the property file information to determine the form type and/or the trading partner submitting the form. Using this information, the proper template and template map are selected from the data base 110 for file conversion. This process will work for Rich Documents with appropriately stored document property information.

In the case that there is no property information, during the template mapping process, the TDM 123 prompts for the form identifier. This would be a field within the document that clearly identifies the document. It might be a bar code or some of the constants within the document.

Scanned or faxed images do not have discrete fields within them. Therefore, a concept of zone identification is required to define via x/y axis, exactly where a field exists on the image. As each zone is defined, it is correlated to a field in the template.

The Document Conversion Engine 92 will scan the document looking for the pre-defined zones (x/y axis). It will read the information in the zone and drop it into the mapped field in the document template. As the scan engine (ScanSoft or some other image scan engine) reads the zones, it creates a confidence factor, by zone. An image zone mapper (135) IZM will prompt the user during the zoning process as to what confidence factor to apply, per zone. If the scan engine applies a confidence factor lower than that set by the user, the zone in question will be highlighted in the template, and the document will be sent to the error correction queue for further processing on a client machine. The template mapper 124B and the image zone mapper 135 may use the mapping tools provided by the template schema creator 136.

The Viewer 137 is a dockable window on the client machine that shows the source document. It handles all document types. The viewer insures document integrity by forcing a split screen paradigm, where one window shows the source document and is never editable, while a second window displays the appropriate template with the mapped fields appropriately populated. Only the data in the template is allowed to be modified.

In an exemplary embodiment, the product may produce a browser-based viewer.

The Template Manager (TM) 124C is the organizer for all the forms, templates, zone files and trading partner associations. It uses the standard Microsoft Windows file management paradigm.

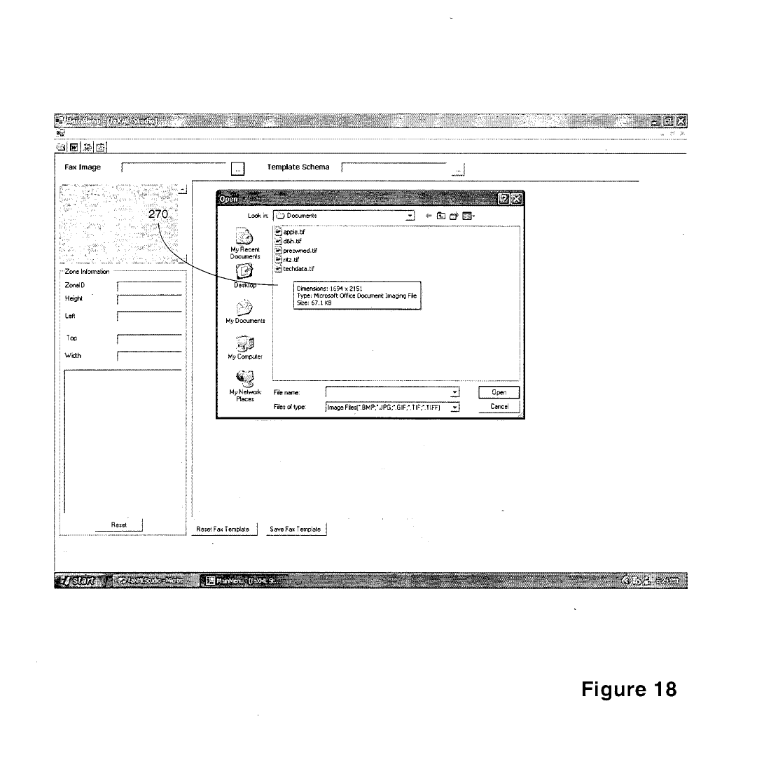

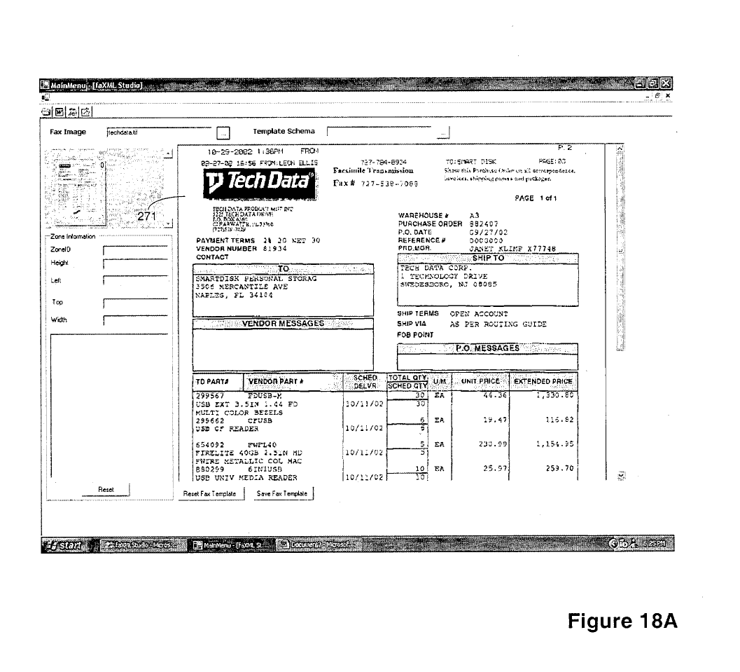

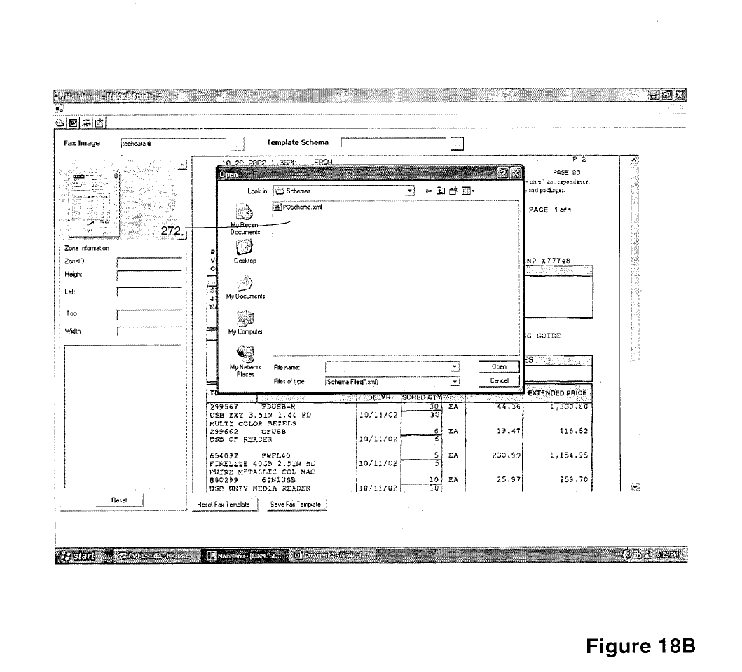

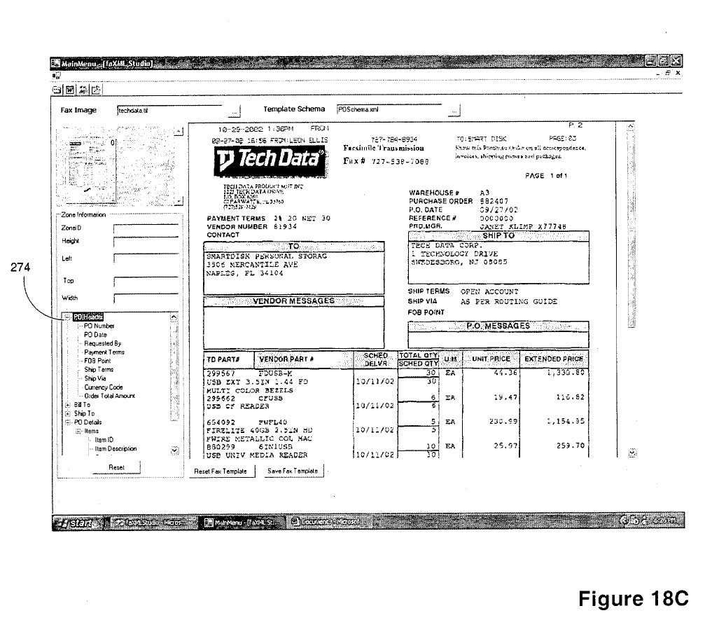

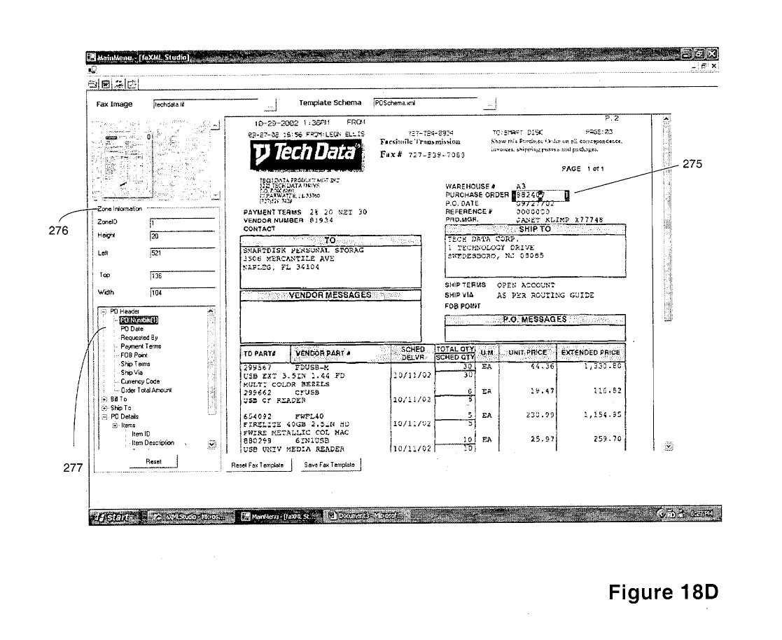

FIGS. 18, 18A, 18B, 18C and 18D are exemplary embodiments which illustrate the process of mapping raw input data to fields in a template as performed by the user of the template designer 123 described above. In the mapping process, zones in an original document are stepped through one by one and associated with a previously designed template zone. For example, FIGS. 18 and 18A are an illustrative facsimiled purchase order which must be converted into a previously defined template purchase order. As shown in FIG. 18, a representative “purchase order” is selected 270. In FIG. 18A a “purchase order” 271 from Tech Data is displayed. FIG. 18B shows the selection of the representative Purchase Order Template 272 being selected. The schema is loaded and displayed as, for example, shown in FIG. 18C 274. The field on the original form is highlighted as shown at 275. The highlighting operation serves to uniquely identify the location of, for example, the “purchase order” field 275 in a user's facsimiled purchase order document. The resultant x/y axis points are displayed in the template Zone Information 276 section, thus mapping a data field in the scanned image to the template.

In a tree structure portion of the display screen 277, the various fields of the predefined template are identified. The “purchase order” field in the tree structure is highlighted and thereby selected to associate the original image purchase order zone with the predefined template purchase order zone. In this manner, all required raw data may be mapped to the required fields of the standard document template. Thereafter, the next time the customer's purchase order is read, the system will be able to automatically determine where the required data on the form is located and how to map such data to the corresponding portions of the standardized purchase order template. After all the required data is “zoned,” the document is then saved for further use in the document conversion process.

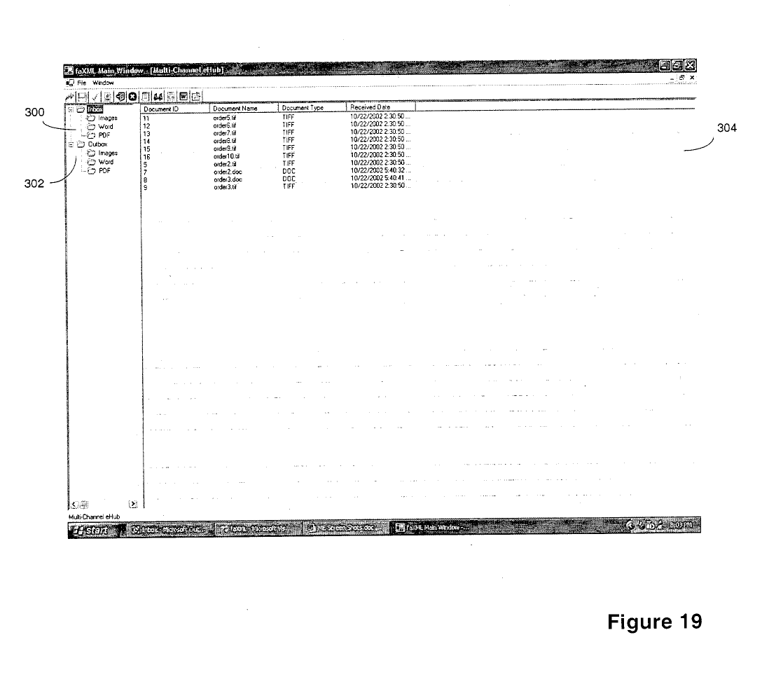

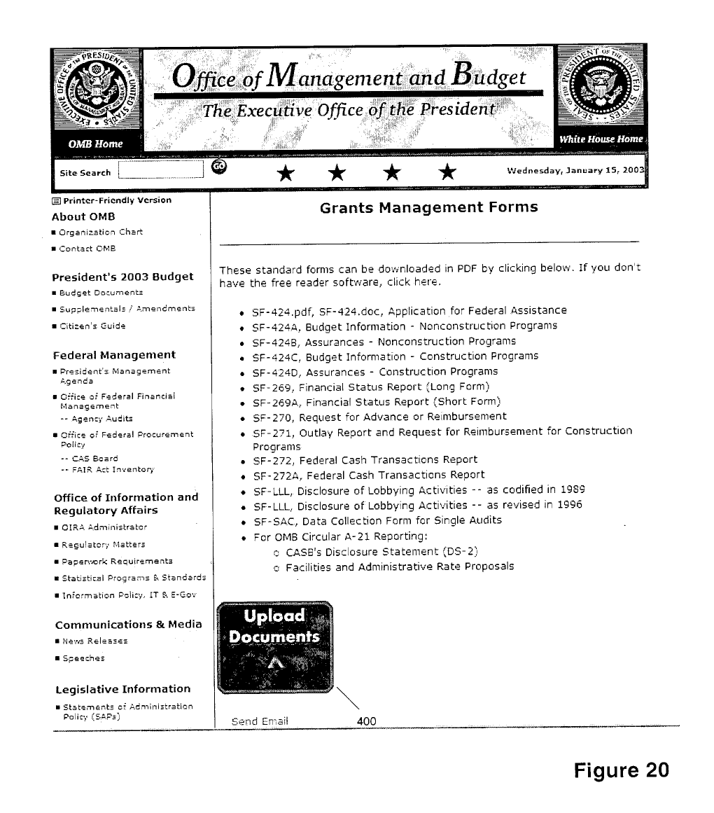

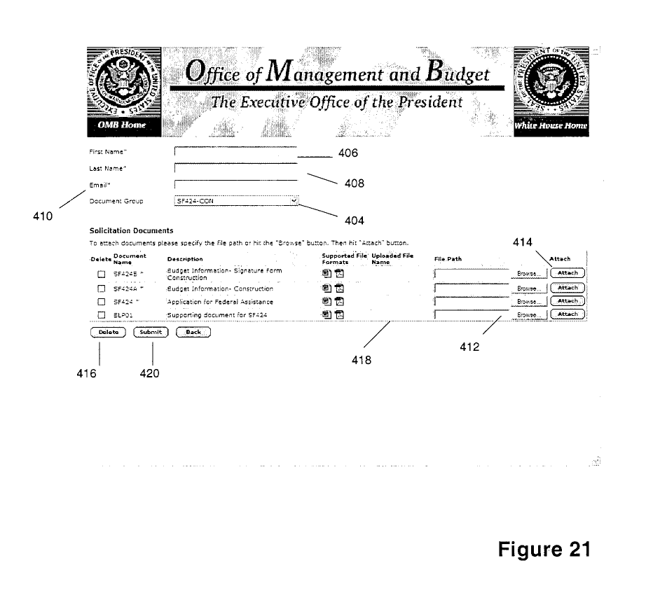

FIG. 19 is an exemplary screen display used by a customer service representative at the document correction utility 127 who is responsible for addressing document conversion errors by making appropriate corrections where possible. As shown on the left hand portion of the display, an in-box 300 and out-box 302 are provided for unprocessed and processed forms, respectively. The unprocessed forms are those forms that could not be successfully converted. As shown in FIG. 19, the forms, for purposes of illustration only, are categorized into different document types, including image, Word, and PDF documents. Screen display portion 304 shows the portion of the in-box resulting from the “images” field being selected. The user may then click on one of the identified image document names and retrieve it for screen display. By, for example, clicking on the first shown document “order5.tif,” the original document shown in FIG. 7 is accessed, displayed in one display window, together with the associated template in a second displayed window, as is also shown in FIG. 7.

The customer service representative, after looking at the bottom window showing the template document zones will be able to recognize what zones in the template purchase order form were not correctly filled and will be able to make appropriate corrections where possible. After the corrections are made, the document may be saved, an XML document will be generated and the previously described process for document conversion may be completed. In an exemplary embodiment, the XML format is the standard format into which all disparate purchase orders will ultimately be converted. This will result in one standard purchase order format, and will define the manner in which the system stores the customer raw data. It also may be the desired format that the line of business application expects for processing for delivery to the end user.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

1. A method of generating a digital document of a predetermined format comprising the steps of:
receiving a first document having a user-based format from a remotely located user;
creating a document template for said user by processing said first document;
receiving a second document from said user;
determining whether said second document has said user based format; and
converting said second document to said predetermined format using said document template.

2. A method according to claim 1, wherein said first document is a document which had been transmitted by said remotely located user by facsimile.

3. A method according to claim 2, where said facsimile was performed using e-Fax.

4. A method according to claim 1, wherein said first document is a PDF document.

5. A method according to claim 1, wherein said first document is a machine-readable document.

6. A method according to claim 1, further including the step of storing an association of said remotely located user with said user related format.

7. A method according to claim 1, wherein converting step includes the step of extracting data from said first document and mapping said data onto said template document.

8. A method according to claim 1, wherein converting step includes the step of generating an XML document.

9. A method according to claim 1, wherein said converting step includes the step of converting said first document into an intermediate document where embedded tags define the data fields.

10. A method according to claim 9, further including the step of converting said intermediate document into said predetermined format.

11. A method according to claim 1, wherein said predetermined format is an EDI purchase order.

12. A method according to claim 1, wherein said predetermined format is a format specified by a governmental entity.

13. A method according to claim 1, further including the steps of detecting an error occurring during the converting step; and correcting said detected error.

14. A method according to claim 1, further including the steps of displaying said first document; and displaying said template.

15. A method of generating a digital document of a predetermined format comprising the steps of:
receiving a first document having a user-based format having a plurality of fields from a remotely located user;
creating a document template for said user by processing said first document;
storing data in a data base identifying a predetermined characteristic of at least one of said plurality of fields;
receiving a second document having a plurality of fields from said user;
determining whether said second document has said user based format;
converting said second document to said predetermined format using said document template; and
determining whether an error has occurred during the converting step by determining whether at least one field in said second document has said predetermined characteristic.

16. A method according to claim 15, wherein said predetermined characteristic is that the field consists of numeric data.

17. A method according to claim 15, wherein said predetermined characteristic is that the field consists of both numeric data and alphabetic data.

18. A method according to claim 15, wherein said predetermined characteristic is that the field is an address field.

19. A method according to claim 15, wherein said predetermined characteristic is that the field is a purchase order number field.

20. A method according to claim 15, wherein said predetermined characteristic is that the field is to be validated by an external system.

21. A method of processing facsimile documents and for generating a digital document of a predetermined format comprising the steps of:
receiving a facsimile document having a user-based format from a remotely located user;
extracting data from various fields of said facsimile document;
mapping the extracted data onto a document template associated with said user-based format; and
converting said facsimile document having a user-based format to a digital document having said predetermined format using said document template.

22. A method according to claim 21, wherein said predetermined format is the format for a purchase order.

23. A method according to claim 21, wherein said predetermined format is the format for a government form.

24. A method according to claim 21, further including the step of storing an association of said remotely located user with said user related format.

25. A method according to claim 21, further including the step of identifying the received document as being a facsimile document.

26. A method according to claim 21, further including the step of storing the received document in a document queue.

27. A method according to claim 21, wherein said received document is an e-Fax facsimile document.

28. A method according to claim 21, wherein converting step includes the step of generating an XML document.

29. A method according to claim 21, wherein said converting step includes the step of converting said first document into an intermediate document where embedded tags define the data fields.

30. A method according to claim 29, further including the step of converting said intermediate document into said predetermined format.

31. A method of generating digital documents of a predetermined format comprising the steps of:
receiving a first document of a first type having a first user-based format from a remotely located first user;
receiving a second document of a second type having a second user-based format from a remotely located second user;
packaging said first document as an attachment to a first e-mail transmission;
packaging said second document as an attachment to a second e-mail transmission; and
extracting the first document and the second document from said first and second e-mail transmissions, respectively;
converting said first document to said predetermined format; and
converting said second document to said predetermined format.

32. A method according to claim 31, wherein said predetermined format is an EDI document.

33. A method according to claim 31, wherein said predetermined format is the format for a purchase order.

34. A method according to claim 31, wherein said predetermined format is the format for a government form.

35. A method according to claim 31, further including the step of storing an association of said remotely located first user with said first user related format.

36. A method according to claim 31, further including the step of creating a document template for said user by analyzing said first document.

37. A method according to claim 31, further including the step of
extracting data from various fields of said first document;
mapping the extracted data onto a document template associated with said first user-based format; and
converting said first document having a user-based format to a digital document having said predetermined format using said document template.

38. A method according to claim 31, wherein said first document and said second document are received via the Internet.

39. A method according to claim 31, further including the steps of:
receiving a third document via physical postal mail;
optically scanning said third document;
packaging the optically scanned third document as an attachment to a third e-mail transmission; and
converting the attachment to said third e-mail transmission to said predetermined attachment.

40. A method according to claim 31, further including the step of storing e-mail attachments into a data base organized as least in part by document type.

41. A method of processing documents of different types and generating a digital document of a predetermined format comprising the steps of:
receiving a document having a user-based format from a remotely located user;
accessing a template document related to said user-based format;
displaying said document having a user-based format in a first window of a display screen;
displaying said template document in a second window of said display screen;
identifying a first data field on said document having a user-based format;
linking said first data field on said document having a user-based format with a field on said template document; and
converting said document having a user-based format to a digital document having said predetermined format in part through said linking step.

42. A method according to claim 41, wherein said predetermined format is the format for a purchase order.

43. A method according to claim 41, wherein said predetermined format is the format for a government form.

44. A method according to claim 41, further including the step of identifying the received document as being a facsimile document.

45. A method according to claim 41, further including the step of storing the received document in a document queue.

46. A method according to claim 41, wherein said received document is an e-Fax facsimile document.

47. A method according to claim 41, wherein said converting step includes the step of generating an XML document.

48. A method according to claim 41, wherein said converting step includes the step of converting said first document into an intermediate document where embedded tags define the data fields.

49. A method according to claim 41, further including the step of packaging said first document as an attachment to an e-mail transmission.

50. A method according to claim 49, further including the step of storing said attachment in a data base organized as least in part by document type.

51. A computer system for generating digital documents of a predetermined format comprising:
an electronic document receiver for receiving a first document of a first type having a first user-based format from a remotely located first user and a second document of a second type having a second user-based format from a remotely located second user;
a mail send processing system, operatively coupled to said electronic document receiver, for packaging said first document as an attachment to a first e-mail transmission and for packaging said second document as an attachment to a second e-mail transmission;
an electronic mail extractor for extracting the first document and the second document from said first and second e-mail transmissions, respectively; and
a document conversion processing system for converting said first document to said predetermined format and for converting said second document to said predetermined format.

52. A system according to claim 1, wherein said predetermined format is an EDI document.

53. A system according to claim 1, wherein said predetermined format is the format for a purchase order.

54. A system according to claim 1, wherein said predetermined format is the format for a government form.

55. A system according to claim 4, wherein said government form is for an application for a government grant.

56. A system according to claim 1, further comprising:
a template designer for creating a document template for said user by analyzing said first document.

57. A system according to claim 1, further comprising:
an infrastructure control module for monitoring the operation of said document conversion system.

58. A system according to claim 1, further comprising:
an infrastructure control module for performing system set up tasks.

59. A system according to claim 57, wherein said infrastructure control module is a browser-based user interface.

60. A system according to claim 58, wherein said infrastructure control module is a browser-based user interface

61. A system according to claim 1, wherein said mail extractor is operable to retrieve e-mail messages and to determine for each retrieved e-mail message the number of attachments that are associated therewith.

62. A system according to claim 1, further including a data base for storing documents and an e-mail server for receiving said first e-mail transmission and said second e-mail transmission.

63. A system according to claim 62, wherein said data base receives e-mail attachments for storage from said electronic mail extractor.

64. A method of generating digital documents of a predetermined format comprising the steps of:
receiving electronic documents as e-mail attachments by a mail server;
storing said electronic documents in a data base;
retrieving an electronic document from said data base;
converting the retrieved document to an intermediate format in which identifying tags are associated with fields in the document; and
transforming the intermediate format into said predetermined format.

65. A method according to claim 64, further including the step of storing mail header information associated with an electronic document.

66. A method according to claim 64, further including the step of storing a document identifier associated with each document.

67. A method according to claim 64, further including the step of generating a status table storing an indication of the status of each of a plurality of documents being converted.

68. A method according to claim 64, further including the step of monitoring the processing of each document being converted.

69. A method according to claim 64, wherein said intermediate format is XML.

70. A method according to claim 67, further including the step of updating the status table when a document has been successfully transformed into said predetermined format.

71. A method according to claim 64, wherein said predetermined format is an EDI format.

72. A method of appending to digital documents supplemental information comprising the steps of:
retrieving from a database a digital document which has been converted from a first format to a standard format;
appending supplemental information to said digital document;
tracking said supplemental information added to said digital document by associating identifying tags with each change; and
storing said supplemental information added to said digital document and said associated tags in a data base.

73. A method according to claim 72, further including the step of retrieving a converted document associated with a given user.

74. A method according to claim 72, further including the step of storing supplemental information in the body of a document previously converted to said standard format;

75. A method of routing digital documents from one person to another comprising the steps of:
prompting the user to supply routing information for a digital document that has been changed from a previous version of said document, said routing information including a destination ID;
routing said digital document to a recipient associated with said destination ID;
notifying said recipient associated with said destination ID of the receipt of said digital document; and
identifying to said recipient changes made to said digital document.

76. A method according to claim 75, further including the step of prompting said recipient to identify the next person to receive the digital document.

77. A method according to claim 76, further including the step of storing routing information related to said document.

78. A method according to claim 75, further including the step of identifying added textual information contained in said digital document.
